(19) United States
(12) Patent Application Publication
(10) Pub. No.: US 2004/0003498 A1
(43) Pub. Date: Jan. 8, 2004

(54) Electrical connector and method of making the same

(76) Inventors: Dean D. Swearingen, Clinton Township, MI (US); Joseph J. Koch, Harrison Township, MI (US)

Correspondence Address: BLANK ROME LLP, THE FARRAGUT BUILDING, SUITE 1000, 900 17TH STREET, NW, WASHINGTON, DC, 20006, US

(21) Appl. No.: 10/423,951

(22) Filed: Apr. 28, 2003

Related U.S. Application Data
(63) Continuation of application No. 09/568,910, filed on May 11, 2000, now abandoned.
(60) Provisional application No. 60/134,021, filed on May 12, 1999.

(51) Int. Cl. H01R 24/00; H01R 33/20; H01R 13/64

(52) U.S. Cl. 29/862; 29/854; 439/677; 439/675; 29/861

(57) ABSTRACT

An electrical connector and method of making the same includes a radially resilient, cylindrical electrical contact member having a plurality of spaced strips extending between opposite ends of a sleeve. The ends of the strips are held in one or more housings in an angularly offset, end-to-end position. The contact member and the sleeve are urged from the one or more housings into a cylindrical portion of a holder or use element to mount the connector directly in the holder or use element. In one aspect, the contact strips are formed as individual strips joined to the sleeve at one end and at the other end. In another aspect, at least one contact strip is formed with a movable detent releasably engagable in a recess in a pin insertable into the connector to lock the pin in the connector. In another aspect, at least one strip has an extension which overlays a portion of the bare wire end of an electrical conductor mounted in one end of a terminal. A wire crimp collar on the terminal is bendable about the strip extension and the bare wire end to electrically engage the collar, the bare wire end of the conductor terminal and the contact strip.

### CROSS REFERENCE CO-PENDING APPLICATION

This application claims the benefit of the priority date of U.S. Provisional Patent Applications Serial No. 60/134,021, filed May 12, 1999, the contents of which are incorporated herein in their entirety.

### BACKGROUND

The present invention relates, in general, to electrical connectors and, more specifically, to radially resilient electrical sockets, also referred to as barrel terminals, in which a cylindrical electrical prong or pin is axially inserted into a socket whose interior surface is defined by a plurality of contact strips or wires mounted within a cylindrical sleeve and inclined between angularly offset ends.

Radially resilient electrical sockets or barrel terminals are a well known type of electrical connector as shown in U.S. Pat. Nos. 4,657,335 and 4,734,063, both assigned to the assignee of the present invention.

In such electrical sockets or barrel terminals, a generally rectangular stamping is formed with two transversely extending webs spaced inwardly from and parallel to opposite end edges of the sheet. Between the inner side edges of the transverse web, a plurality of uniformly spaced, parallel slots are formed to define a plurality of uniformly spaced, parallel, longitudinally extending strips which are joined at opposite ends to the inward side edges of both transverse webs. Other longitudinally extending slots are coaxially formed in the sheet and extend inwardly from the end edges of the blank to the outer side edges of the transverse webs to form a plurality of uniformly spaced, longitudinally extending tabs projecting outwardly from each transverse web.

The blank or sheet is then formed into a cylinder with the longitudinal strips extending parallel to the axis of the now cylindrical sheet. A closely fitting cylindrical sleeve is slipped coaxially around the outer periphery of the cylindrical blank, and extends axially substantially between the outer edges of the transverse webs. The mounting tabs at each end of the blank are then bent outwardly across end edges of the sleeve into radially extending relationship to the sleeve.

A relatively tight-fitting annular collar or outer barrel is then axially advanced against the radially projecting tabs at one end of the sleeve and slipped over the one end of the sleeve driving the tabs at that end of the sleeve downwardly into face-to-face engagement with the outer surface of the one end of the sleeve. The fit of the annular collar to the sleeve is chosen so that the end of the cylindrical blank at which the collar is located is fixedly clamped to the sleeve against both axial or rotary movement relative to the sleeve. A tool typically having an annular array of uniformly spaced, axially projecting teeth is then engaged with the radially projecting tabs at the opposite end of the sleeve. The teeth on the tool are located to project axially between the radially projecting tabs closely adjacent to the outer surface of the cylindrical sleeve. The tool is then rotated about the longitudinal axis of the cylindrical sleeve while the sleeve is held stationary to rotatably displace the engaged tabs approximately 15° to 45° from their original rotative orientation relative to the sleeve and the bent over tabs at the opposite end of the sleeve. The tool is then withdrawn and a second annular collar or outer barrel is force fitted over the tabs and the sleeve to fixedly locate the opposite end of the blank in a rotatably offset position established by the tool. When completed, such an electrical socket has longitudinal strips extending generally along a straight line between the angularly offset locations adjacent the opposite ends of the cylindrical sleeve. The internal envelope cooperatively defined by the longitudinal strips is a surface of revolution coaxial to the axis of the cylindrical sleeve having equal maximum radii at the points where the strips are joined to the respective webs and a somewhat smaller radius midway of the length of the strips. The minimum radius, midway between the opposite ends of the strips, is selected to be slightly less than the radius of a cylindrical connector pin which is to be inserted into the barrel socket so that the insertion of the pin requires the individual longitudinal strips to stretch slightly longitudinally to firmly frictionally grip the pin when it is seated within the barrel socket.

To put it another way, because of the angular offset orientation of the opposed ends of each of the strips, each strip is spaced from the inner wall of the sleeve in a radial direction progressively reaching a maximum radial spacing with respect to the outer sleeve midway between the ends of the sleeve.

Such a radially resilient electrical barrel socket provides an effective electrical connector which provides secure engagement with an insertable pin; while still enabling easy manual withdrawal or insertion of the pin relative to the socket. Such connectors also provide a large electrical contact area between the pin and the socket which enables such connectors to be employed in high current applications.

It is also known to construct such an electrical connector in a manner in which one of the collars is formed as an integral part or extension of a support member forming a part of the overall connector as shown in FIG. 20. The afore described assembly process remains the same except that the separate collars at both ends of the socket are replaced by one collar at one end and a hollow, cylindrical extension of a connector which can be inserted into or otherwise electrically connected to an electrical device, such as a vehicle alternator, etc. As shown in FIG. 20, the hollow cylindrical end of the support receives and holds the tabs at the first end of the sleeve tight against rotation while the opposing tabs are angularly rotated. A collar or end cap is then clamped over the rotated tabs to maintain such tabs in the rotated position.

However, it is believed that further modifications or enhancements could be made to such radially resilient electrical sockets to reduce the manufacturing cost as well as to simplify the mounting or attachment of such sockets or terminals to an electrical device to which they are to be electrically connected.

### SUMMARY

The present invention is, according to one aspect, an electrical connector having an improved radially resilient electrical socket or barrel terminal forming a part thereof which has a significantly reduced manufacturing cost and, at the same time, a simplified construction for mounting in an associated electrical device.

According to one aspect of the present invention, an electrical connector apparatus comprises: a holder having a cylindrical portion with a bore extending at least from one end; a barrel terminal coaxially received within the cylindrical portion of the housing, the barrel terminal including: a contactor member formed of a one piece sheet having a pair of axially spaced, coaxial, annular webs fixedly seated against the inner surface of a cylindrical sleeve; a plurality of elongate strips integrally joined at one end to one of the webs and integrally joined at an opposite end to the other of the webs, the strips being joined to the webs at uniformly spaced intervals about the respective circumferences of the webs; the location at which each strip is joined to said one of the webs being angularly displaced about the common axis of the webs from the location at which the strip is joined to the other of the webs; a plurality of mounting tabs integrally joined to each web and extending from the respective web around an adjacent end edge of the cylindrical sleeve and into face-to-face engagement with an outer surface of the sleeve; and wherein: the inner surface of the bore in the cylindrical portion of the holder fixes the tabs into face-to-face engagement with the outer surface of the sleeve.

The holder preferably includes an electrical conductive portion connectable to an electrical use device. An electrically conductive pin is insertable into the barrel terminal into electrical contact with the strips.

A plurality of longitudinally axially extending grooves are formed in the cylindrical portion of the holder. The folded tabs at each opposite end of the barrel terminal slidably engage and are axially and rotatably fixed within the grooves in the cylindrical portion of the holder when the barrel terminal is seated in the bore in the cylindrical portion of the holder.

In one aspect, the holder is formed as a unitary, one piece part of an electrical use device.

In another aspect, the contact member has a plurality of strips extending from one end of the blank. The strips are folded over the interior of the blank before the blank is formed into a cylindrical shape forming the cylindrical sleeve. The opposite ends of the contact strips are folded over the exterior surface of the sleeve, are shortened and engaged with the end surface of the sleeve or are further shortened and disposed completely interiorly within the sleeve. In all cases, the opposite ends of the contact strips are fixedly joined to the sleeve, such as by welding.

In another aspect, the connector has an intermediate portion of each strip fixedly attached to the cylindrical sleeve. The opposed ends of each strip extend oppositely from the intermediate fixed portion and are angularly offset with respect to a longitudinal axis of the sleeve from the fixed intermediate portion of each strip. The longitudinally outer ends of each strip are fixed to the sleeve in the angular offset position.

In yet another aspect, at least one of the strips has a projection extending radially inward. The projection is releasably engagable with the recess in a conductive pin insertable through the sleeve to releasably lock the pin in the sleeve.

In yet another embodiment, the strips are joined to and extend from opposite ends joined to webs extending transversely to the opposed ends of the strips. A plurality of tabs project longitudinally from each web. The strips are preformed at an angle between the webs to increase the spring force exerted on a conductive pin inserted into the cylindrical sleeve.

In another embodiment, an annular projection is disposed intermediate the ends of the sleeve and biases an intermediate portion of each strip radially inward. The projection is preferably in the form of an annular band carried on the sleeve.

In yet another aspect, the plurality of strips are mounted interiorly within a cylindrical blank and have first and second ends fixed to the first and second ends of the blank. A plurality of slots are formed in the blank, nominally extending at an angle with respect to the strips. One end of the cylindrical blank is angularly offset with respect to the opposite end to bring the slots into substantial coaxial alignment with the longitudinal axis of the cylindrical blank. In this position, one of each strip is angularly offset from the second end of each strip.

In yet another aspect of the inventive electrical connector, contact members are formed of first and second coaxially arranged contact blanks having facing first end and opposed second ends. The plurality of strips are mounted interiorly within the first and second blanks with a first end of each strip fixed to the first blank and the second end of each strip fixed to the second blank. The second end of the blank is angularly offset with respect to a longitudinal axis through the first and second blanks from the opposed end of the first blank such that the first end of each strip is angularly offset from the second end of each strip with respect to the longitudinal axis.

In another aspect of the invention, the strips are formed of a continuous angularly expanded contact member with alternating ends of adjacent strips fixedly joined to each other by a solid metal portion of the contact member, the solid metal portions alternating from ends-to-ends of adjacent strips. The opposite ends of the strips are joined to opposite ends of first and second cylindrical sleeves. One end of each strip and one sleeve is angularly offset from the opposite end of the respective strip, with the sleeves fixed in the angular offset position to maintain the ends of the strips in the angular offset position.

In another aspect, at least one strip in the contact member has an extension projecting from one end of the contact member. A detent is formed in the extension adapted to engage a recess formed in a conductive member insertable into the connector to forcibly retain the conductive member within the connector. The detent is shapable to provide any insertion and/or removal force, including a shape to prevent removal of the conductive member after the projection has engaged the recess in the conductive member.

In yet another aspect of the invention, an extension projects from at least one strip on the contact member which is mounted in a cylindrical portion of a terminal. The extension overlays and is spaced from an end portion of the terminal which carries at least one bendable wire crimp collar. The extension on the strip and the end portion of the terminal receive the bare wire end of an electrical conductor, with the wire crimp collar bendable over and into contact with the strip extension and directly into electrical contact with the bare wire end.

According to another aspect of the present invention, a unique method of manufacturing an electrical connector apparatus is disclosed. The method comprises the steps of:

forming a flat rectangular sheet metal blank with a plurality of uniformly spaced, parallel, longitudinal strips integrally joined at opposite ends to a pair of spaced, parallel connecting webs extending continuously transversely across said blank in inwardly spaced, parallel relationship to the opposed end edges of the blank, and a plurality of spaced, longitudinally extending tabs projecting axially from each web to the opposed end edges of the blank;

forming the blank into a cylinder having a longitudinal axis parallel to the longitudinal strips;

inserting the cylindrical blank into a close fitting cylindrical sleeve having an axial length substantially equal to the distance between the outer edges of the webs of the blanks;

flaring the tabs at one end of the blank outwardly across the outer end of the sleeve to positions projecting radially outwardly from the axis of the sleeve;

bending the tabs at one end of the cylindrical blank into face-to-face engagement with an outer surface of the sleeve as the tabs and one end of the sleeve are inserted into a bore in a first housing;

bending the tabs at the opposite end of the cylindrical blank through a predetermined angle relative to the sleeve;

rotating the tabs at the one end a predetermined angular displacement from the tabs at the other end of the blank;

then continuing the bending of the tabs at the other end of the cylindrical blank into face-to-face engagement with the outer surface of the sleeve as the tabs at the other end of the cylindrical blank are inserted into a second housing coaxially aligned with the first housing and disposed in close proximity with the first housing;

aligning the coaxial first and second housings with a cylindrical portion of a holder; and

pushing the cylindrical sleeve and cylindrical blank from the first and second housings into the cylindrical portion of the holder wherein the cylindrical portion of the holder maintains the folded over tabs at both ends of the cylindrical blank in face-to-face engagement with the cylindrical sleeve and the tabs at one end of the cylindrical blank angularly offset from the tabs at the opposite end of the cylindrical blank.

In another aspect, the method comprises:

forming a plurality of longitudinally extending grooves in the cylindrical portion parallel to the longitudinal axis of the cylindrical portion; and inserting each bent over tab at each end of the cylindrical sleeve into one of the grooves as the sleeve is urged into the bore in the cylindrical portion of the holder.

In another aspect of the invention, the method comprises:

forming the contact member of an electrically conductive material in the form of a flat blank having opposed first and second side ends;

forming a plurality of slits alternatingly in the blank, with one strip extending from a first end at one side end of the blank to an opposite end spaced from an opposite side end of the blank in the adjacent slit extending from a first end at the opposite side end of the blank to an opposed end spaced from the first side end of the blank to form solid metal portions at alternating ends of two adjacent strips;

laterally expanding the blank to space one end of two adjacent strips from each other while maintaining the opposed ends of two adjacent strips in contact by the solid metal portion;

fixedly mounting the opposed ends of each strip to first and second spaced flat blanks;

forming the first and second blanks into cylindrical sleeves;

angularly rotating the one so the sleeves with respect to the other sleeve to angularly offset one end of the strips from the opposite end of each strip; and

fixedly connecting the first and second sleeves together to maintain the opposed ends of the contact strips in the angular offset position.

The electrical connector and/or radially resilient electrical socket of the present invention has a significantly reduced cost as compared to previously devised, similar radial resistant electrical sockets due to the elimination of both collars or rings. Further, the radially resistant electrical socket or barrel terminal can be easily installed into well known electrical terminals or holders and be integrated therewith without the need for substantial modification to the existing holders.

### BRIEF DESCRIPTION OF THE DRAWING

The various features, advantages and other uses of the present invention will become more apparent by referring to the following detailed description and drawing in which:

FIG. 1 is a plan view of a flat sheet metal blank employed in constructing a barrel terminal embodying the present invention;

FIG. 2 is a side elevational view of the blank of FIG. 1 formed into a cylinder;

FIG. 3 is a perspective view showing a close fitting cylindrical sleeve disposed about the blank of FIG. 2;

FIG. 4 is a perspective view of a subsequent step in the construction of the barrel terminal;

FIG. 5 is an enlarged side elevational, cross-sectional view showing a subsequent step in the present construction method;

FIG. 6 is an enlarged side elevational, cross-sectional view showing yet another step in the construction method of the present invention;

FIG. 7 is a perspective view depicting another step in the construction method of the present invention;

FIG. 8 is a side elevational, longitudinal cross-sectional view of the temporary assembled state of the barrel terminal of the present invention;

FIG. 9 is an enlarged, side elevational, cross-sectional view of the next step in the construction method of the present invention;

FIG. 10 is an enlarged, side elevational, cross-sectional view of the assembled electrical connector of the present invention;

FIGS. 11-17 are perspective views of separate embodiments of the present invention;

FIG. 17A is an exploded perspective view of the barrel mounted in a use device and receiving a conductive pin;

FIG. 18 is a longitudinal, cross-sectional view of an alternate embodiment of a barrel terminal according to the present invention;

FIG. 19 is an enlarged, partial end view of the assembled barrel terminal of the embodiment shown in FIG. 9;

FIG. 20 is a side elevational, cross sectional view of a prior art electrical connector employing a barrel socket mounted in one end of a holder and receiving an end cap at an opposite end;

FIGS. 21-24 depict sequential steps in an alternate construction method of a barrel socket according to the present invention;

FIG. 25 is an exploded, partially cross section, side elevational view of the completed electrical connector constructed according the method of FIGS. 21-24 shown in an interconnected use position.

FIGS. 26-28 depict sequential steps in the construction method of the present invention for an alternate barrel socket;

FIG. 29 is a perspective view showing multiple means for fixedly mounting the tabs of the contactor to the sleeve;

FIG. 30 is a plan elevational view of an alternate barrel socket blank according to the present invention;

FIG. 31 is a side elevational, longitudinal cross sectional view of an alternate barrel socket according to the present invention;

FIG. 32 is a side elevational, longitudinal cross sectional view showing a barrel socket application according to the present invention used in a quick connect application;

FIG. 33 is a side elevational, longitudinal cross sectional view of an alternate barrel socket construction according to the present invention;

FIG. 34 is a perspective view of an alternate blank used in the barrel socket of the present invention;

FIG. 35 is a partial, longitudinal cross sectional view of yet another alternate barrel socket construction according to the present invention;

FIG. 36 is a plan elevational view of another embodiment of a barrel socket blank according to the present invention;

FIG. 37 is a plan elevational view of a completed barrel socket using the blank shown in FIG. 36 and illustrated in a partially assembled position;

FIG. 38 is a plan elevational view of the barrel socket blank shown in FIG. 37 depicted in a completed assembly position;

FIG. 39 is a an end view of the barrel socket shown in FIG. 38;

FIG. 40 is an alternate embodiment of a barrel socket blank according to the present invention;

FIG. 41 is a plan elevational view of a barrel socket using the blank shown in FIG. 41 and illustrated in a partially assembled position;

FIG. 42 is a plan elevational view of the barrel socket shown in FIG. 41, depicted in a completed assembly position;

FIG. 43 is a plan elevational view of an alternate barrel socket blank according to the present invention shown in an initial manufacturing stage;

FIG. 44 is a plan elevational view of the blank shown in FIG. 43, depicted in an intermediate assembly stage;

FIG. 45 is a side elevational view of a barrel socket using the blank shown in FIGS. 43 and 44, but depicted in a completed assembled state;

FIG. 46 is a longitudinal cross sectional view of another aspect of a connector of the present invention;

FIG. 47 is an enlarged, partial, longitudinal cross sectional view of a modified detent according to the invention depicted in FIG. 46;

FIG. 48 is a longitudinal cross sectional view of another aspect of a connector of the present invention;

FIG. 49 is plan view of another aspect of a contact member usable in a connector according to the present invention;

FIG. 50 is a perspective view of a partially assembled contact blank shown in FIG. 49;

FIG. 51 is a partially broken away, enlarged, plan elevational view of another aspect of a blank usable in a connector according to the present invention;

FIG. 52 is an enlarged, partially broken away, plan view of a subsequent manufacturing state of the blank shown in FIG. 50, with the blank depicted in a laterally expanded state mounted on a two-part outer sleeve;

FIG. 53 is a perspective view of the connector employing the blank and outer sleeve of FIGS. 50 and 51, depicted in a completely assembled state;

FIGS. 53-55 are views similar to FIGS. 51-53, but depicting a modification to the connector shown in FIGS. 51-53.

### DESCRIPTION OF THE PREFERRED EMBODIMENTS

The structure of a barrel socket used in an electrical connector according to one aspect of the present invention is best explained by a description of the manner in which it is manufactured.

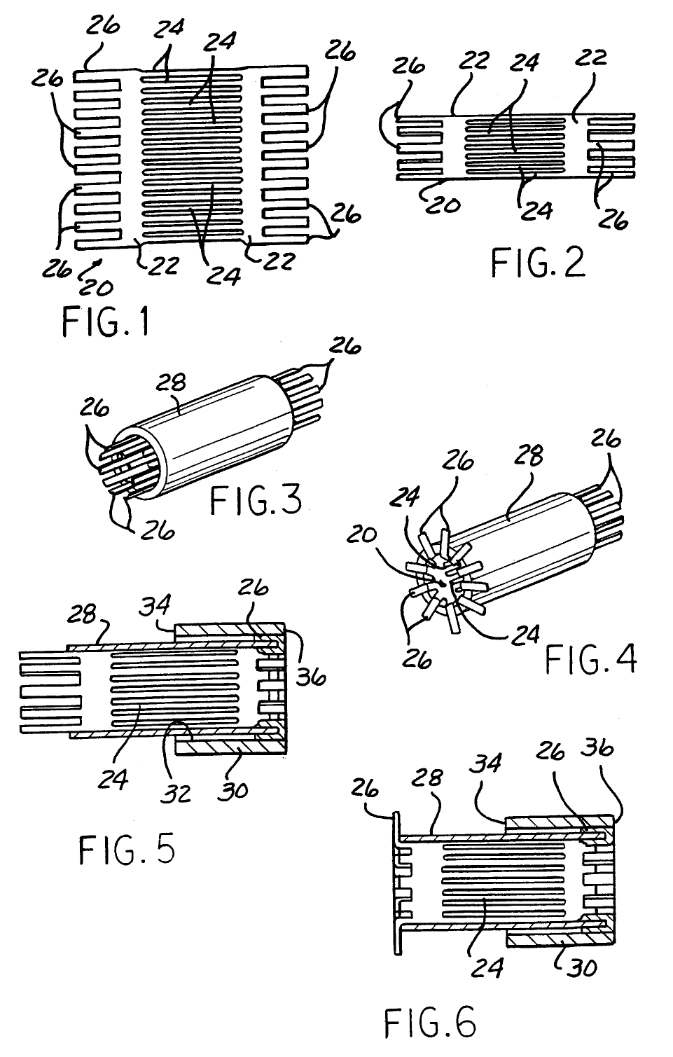

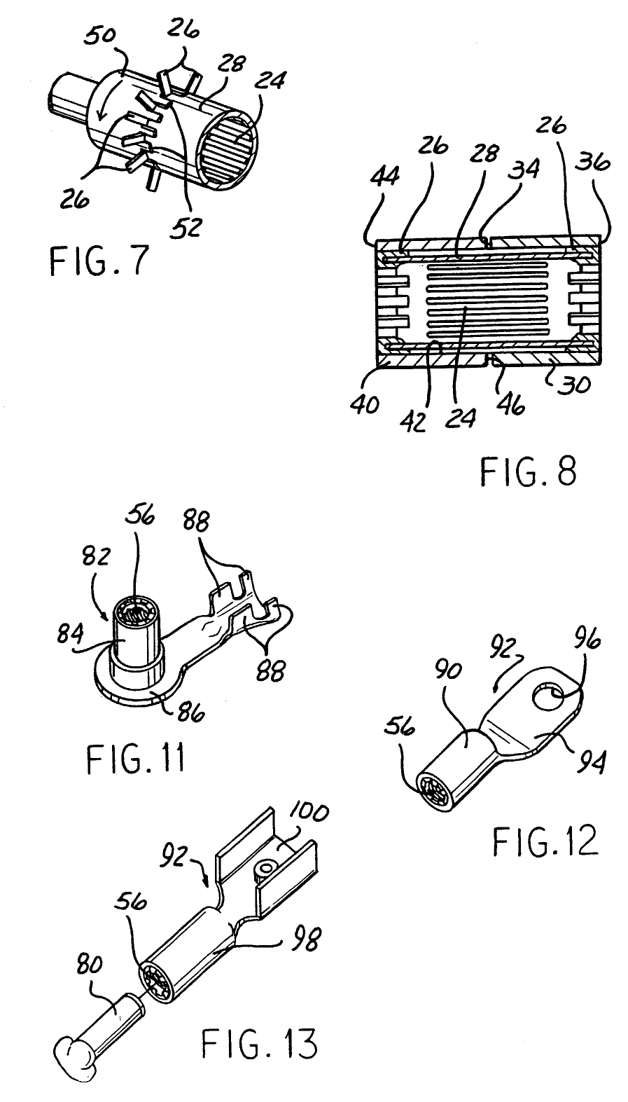

The first step in the manufacture of the barrel socket is the stamping of a blank in the form shown in FIG. 1 from a flat piece of sheet metal which preferably is a beryllium copper alloy which has both mechanical and electrical properties well adapted for this application.

Referring to FIG. 1, the blank designated generally 20 is stamped in a generally rectangular configuration and formed with a pair of spaced, parallel, transversely extending connecting web portions 22 which are integrally connected to each other by a plurality of uniformly spaced, parallel, longitudinally extending strips 24 which extend between the respective inner edges of the webs 22. A plurality of spaced, parallel tabs 26 project longitudinally outwardly from the outer edges of the respective transverse webs 22.

The second step in the manufacturing process is shown in FIG. 2 and finds the blank 20 formed into a horizontal, cylindrical, tubular configuration, the axis of the cylindrical tube extending parallel to the longitudinal strips 24 and tabs 26.

After the blank 20 is formed into the cylindrical tubing configuration of FIG. 2, a close-fitting cylindrical sleeve 28 is slipped over the tube as shown in FIG. 3, the axial length of sleeve 28 being sufficient to extend over both of transverse webs 22 leaving the tabs 26 projecting outwardly from the opposite ends of sleeve 28.

In the next step shown in FIG. 4, the projecting tabs 26 are flared or bent outwardly across one end edge of sleeve 28 to project radially outwardly of the axis of the sleeve.

In the next step of the process shown in FIG. 5, a temporary first housing or fixture 30 has a central bore 32 extending at least from a first end 34 to an opposite end 36. The bore 32 has a diameter larger than the diameter of the cylindrical sleeve 28 by a distance equal to the thickness of the tabs 26. The first housing 30 is axially driven over one end of the sleeve 28 or the sleeve 28 is axially driven into one of the first and second ends 34 and 36 of the first housing 30. The forcible interconnection of the sleeve 28 and the first housing 30 bends the radially flared tabs 26 at the one end of the sleeve 28 back on themselves into overlapping, face-to-face relationship with the outer surface of the sleeve 28. The inner diameter of the bore 32 is chosen such that when the first housing 30 and the first end of the blank 20 and the sleeve 28 are in the position shown in FIG. 5, the first housing 30 exerts sufficient force on the tabs 26 to clamp the tabs 26 against the outer surface of the sleeve 28 to prevent any axial or rotary movement of the tabs 26 relative to the sleeve 28.

Next, as shown in FIG. 6, the tabs 26 at the opposite end of the sleeve 28 are flared or bent radially outwardly across the opposite end edge of the sleeve 28 to project radially outward from the axis of the sleeve 28.

In the next step shown in FIG. 7, a tubular tool 50 having uniformly spaced, axially projecting teeth 52 on one end is engaged with the radially projecting tabs 26 projecting out of one end of the sleeve 28. The internal diameter of the tool 50 is such that it will have a loose, sliding slug fit with the outer diameter of the sleeve 28 and the teeth 52 are so spaced from each other so as to project through the spaces between the adjacent, radially projecting tabs 26.

When the tool 50 is seated with the teeth 52 between the radially projecting tabs 26, the first housing 30 is clamped or otherwise held against rotation and the tool 50 rotated coaxially of the sleeve 28 through a predetermined angle, which is typically from about 15° to about 45°. This action of the tool 50 rotatably offsets one end of the blank or sheet 20 from the previously fixed end held against rotation by the first housing 30 relative to the sleeve 28. The characteristics of the beryllium copper alloy of which the blank or sheet 20 is preferably made is such that, although the material possesses some resiliency, the rotation imparted by the tool 50 permanently sets the blank 20 in the rotated position.

Next, as still shown in FIG. 8, a second housing 40 also having a through bore 42 extending from a first end 44 to an opposed second end 46 is axially driven over the sleeve 28 into interference with the radially outward extending tabs 26 or the ends of the sleeve 28 and the blank 20 extending outward from the first housing 30 are axially driven into the bore 42 in the second housing 40. The second housing 42 is then advanced relative to the first housing 30 to force fit the interior surfaces of the bore 42 in the second housing 40 into engagement with the radially extending, angularly offset tabs 26 thereby bending the tabs 26 over into face-to-face engagement with the outer surface of the other end of the sleeve 28.

The second housing 40 and the first housing 30 are advanced relative to one another into abutment to hold the angularly offset tabs 26 at each end of the sleeve 28 non-movably against the outer surface of the sleeve 28.

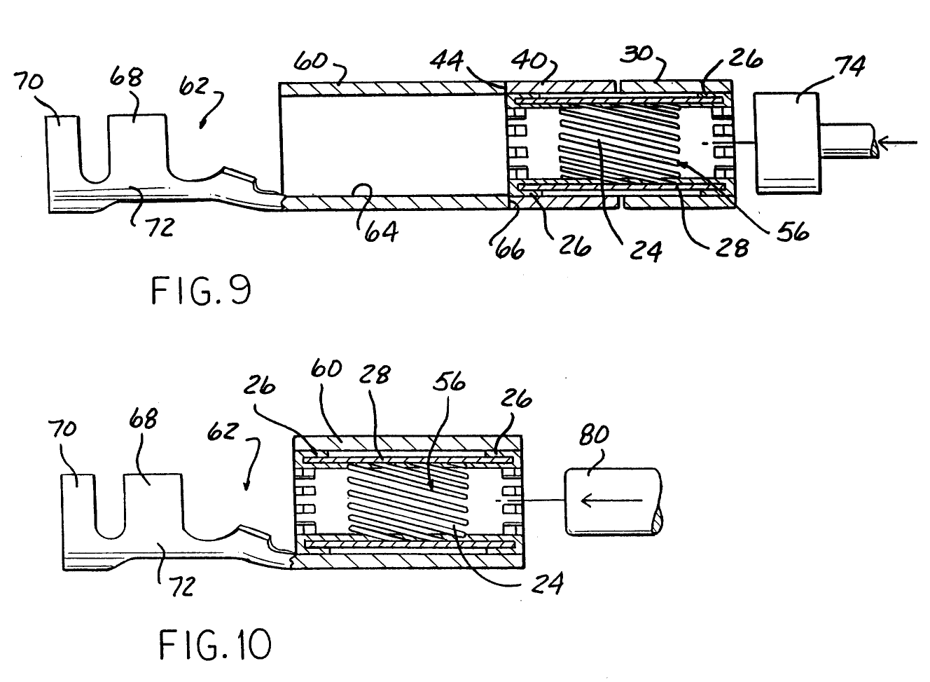

Turning now to FIG. 9, the completed barrel socket denoted by reference number 56, and the aligned first and second housings 30 and 40 which house the barrel socket 56 are then coaxially aligned with one end of a cylindrical portion 60 of a holder, support or electrical use device 62. In the embodiment shown in FIG. 9 by way of example only, the holder or support 62 is illustrated in a form of a terminal having the cylindrical portion 60 at one end with a through bore 64 projecting from an open end 66 and two pairs of bendable collar members 68 and 70 which are integrally formed on an elongated support 72 extending from one edge of the cylindrical portion and which are bendable about an inserted pin or electrical conductor to electrically connect the pin or electrical conductor to the barrel socket 56.

As shown in FIG. 9, when the first and second housings 30 and 40 are aligned with the end 66 of the cylindrical portion 60 of the holder 62, a pusher 74, such as a fluid cylinder or motor driven rod, is advanced through the open end of the first housing 30 into engagement with one end of the barrel socket 56. The pusher 74 pushes the entire barrel socket 56 from the first and second housings 30 and 40 and into the bore 64 of the cylindrical portion 60 of the holder 62 as depicted in FIG. 10 without any loss of holding force on the tabs 26. The inner diameter of the bore 64 in the cylindrical portion 60 is such that the bent over tabs 26 are held in secure, non-axial, non-rotative engagement with the outer surface of the sleeve 28. The barrel socket 56 when mounted in the cylindrical portion 60 of the holder 62 is now ready to receive an external elongated pin or prong 80, as shown in FIG. 10. The diameter of the cylindrical pin 80 is slightly less than the internal diameter of the transverse webs 24 when seated in the sleeve 28, and somewhat greater than the minimum radius of the entire envelope defined by the rotatably offset longitudinal strips 24 of the barrel socket 56. When the pin 80 is fully inserted into the sleeve 28, the pin 80 forces the individual strips 24 to stretch somewhat longitudinally so that the strips 24 can be moved radially outwardly toward the inner surface of the sleeve 28 a sufficient distance to accommodate the insertion of the pin 80. The inner surface of the strips 24, particularly midway of the opposite ends thereof, thus lie tightly against the outer surface of the pin 80 to maintain a firm frictional grip on the pin 80 sufficient to mechanically maintain a connection in the face of normally encountered removal forces. However, the frictional grip is not so tight as to prohibit relatively easy manual withdrawal of the pin 80 from the cylindrical portion 60 of the holder 62.

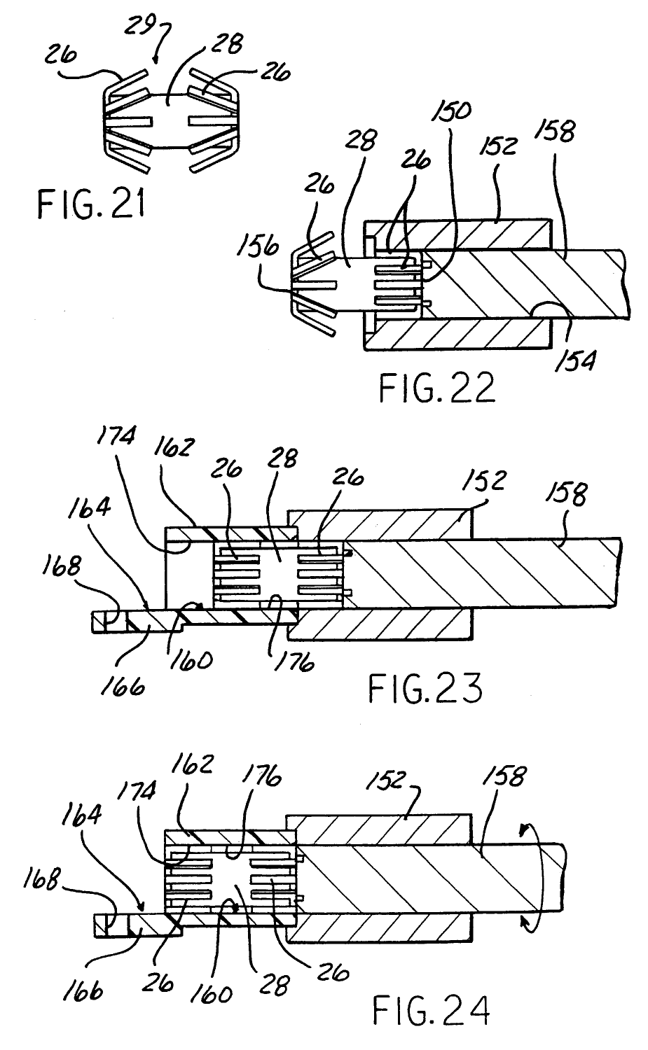

Referring now to FIGS. 21-25, there is depicted the construction steps according to another aspect of the method of the present invention for manufacturing an electrical connector utilizing a radially resilient socket.

In FIG. 21, the sleeve 28 is depicted. This construction stage is similar to that described above and shown in FIG. 4 in which the blank 20 has been bent or formed into a cylinder and the outer sleeve 28 disposed closely there over with the tabs 26 projecting outward from opposite ends of the sleeve 28 as shown in FIG. 3.

However, in this aspect of the present invention, the tabs 26 at both ends of the sleeve 28 are bent or folded around the outer ends of the sleeve 28 and back over the outer surface of the sleeve 28 to form a cartridge 29.

The first end 150 of the cartridge 29 is then inserted into a first housing or fixture 152 having a bore 154 formed therein. The inner diameter of the bore 154 is sized slightly larger than the outer diameter of the sleeve 28 by a distance equal to the thickness of the tabs 26 so as to closely fold over the tabs 26 into face-to-face engagement with the outer surface of the sleeve 28 when the first end 150 of the cartridge 29 is inserted into the first housing 152. It should be noted that the cartridge 29 is only partially inserted into the bore 154 in the first housing 152 such that the second end 156 of the sleeve 28 projects outwardly from the first housing 152 along with the tabs 26 at the second end 156 of the sleeve 28.

The first end 150 of the cartridge 29 is inserted into the bore 154 in the first housing 152 until the first end 150 engages one end of a rotatable tool 158 which is rotatably and axially movably disposed within the bore 154. The tool 158 can be similar to the tool 50 described above and shown in FIG. 7 and has teeth which engage the spaces between adjacent folded over tabs 26 at the first end 150 of the sleeve 28.

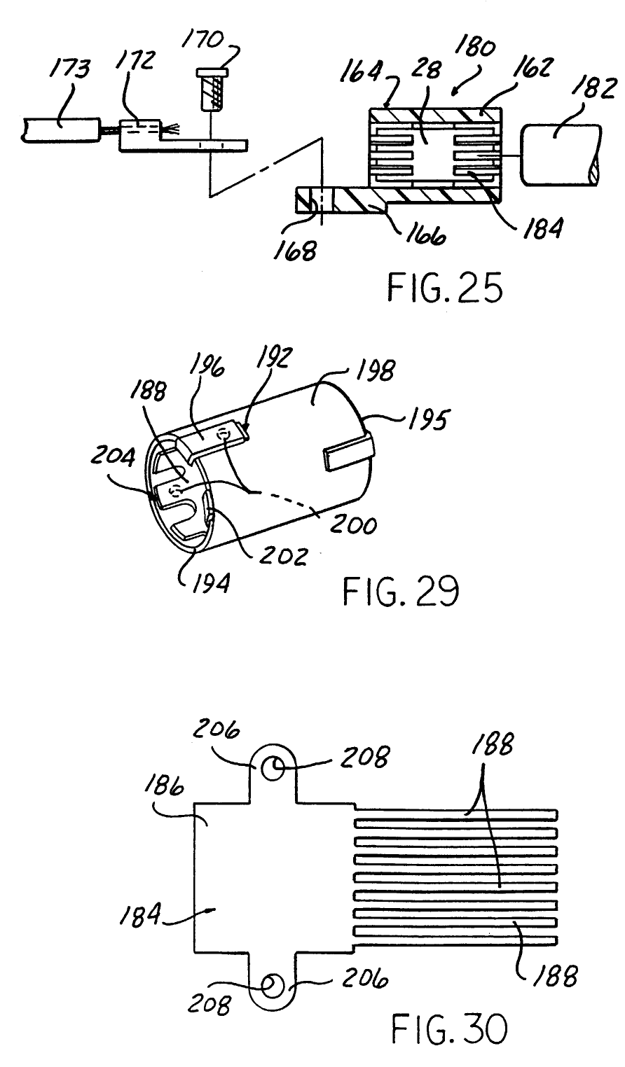

Next, as shown in FIG. 23, the second end 156 of the cartridge 29 is inserted into or otherwise brought into engagement with a bore 160 in a cylindrical portion 162 of a terminal, holder, support or electrical device, all referred to generally hereafter as a holder 164. The cylindrical portion 162 is disposed at one end of a support or base 166, the opposite end of which, by example only, includes an aperture 168 for receiving a fastener 170, shown in FIG. 25, to secure another terminal 172 carrying an electrical conductor, again by example only, to the holder 164.

According to a preferred aspect of the present invention, the bore 160 in the cylindrical portion 162 is divided into two sections, namely, a first end section 174 and a second end section 176. The inner diameter of the first end section 174 is selected to create a press or interference fit with the tabs 26 at the second end 156 of the cartridge 29 when the second end 156 of the cartridge 29 is inserted into the bore 160. The second end section 176 of the bore 160 has a larger diameter than the first end section 174 to enable the second end 156 and the folded tabs 26 on the outer sleeve 28 to pass freely there through into press-fit engagement with the first end section 174 of the bore 160. This forcibly mounts the second end 156 of the cartridge 29 in the cylindrical portion 162 of the holder 164 and brings the tabs 26 at the second end 156 of the outer sleeve 28 into secure electrical contact with the inner surface of the bore 160.

The cartridge 29 is forcible inserted into the bore 160 until the entire outer sleeve and folded over tabs 26 at the first end 150 of the cartridge 29 are fully enclosed within the bore 160 as shown in FIG. 24.

As described above, the second end section 176 of the bore 160 has a larger inner diameter than the adjacent first end section 174. This can be formed in a number of constructions, including a gradual decreasing diameter taper along the length of the bore 160 from the first end section 176 to the second end section 178. Alternately, a step may be formed intermediate the ends of the cylindrical portion 162 to form two different diameter sections, one for the first end section 174 and the other for the second end section 176 of the bore 160.

As shown in FIG. 24, when the cartridge 29 is fully inserted into the bore 160, the second end 156 of the cartridge 29 and the folded over tabs 26 carried on the second end 156 are in a press-fit engagement with the inner surfaces of the cylindrical portion 162 surrounding the bore 160. However, the tabs 26 at the opposite end of the cartridge 29 will only be loosely disposed between the inner surfaces of the second end section 176 of the bore 160 and the adjacent outer surface of the sleeve 28.

The rotatable tool 158 can be advanced by a suitable drive source, such as a pressurized fluid cylinder, electric motor drive, etc., to sidably urge the first end 150 of the cartridge 29 and the folded over tabs 26 carried thereon from the first housing 156 into the bore 160 in the cylindrical portion 162 of the holder 164.

Next, as shown by the arrow in FIG. 24, the rotatable tool 158 is rotated to angularly offset the tabs 26 at the first end 150 of the cartridge 29 from the corresponding tabs 26 at the second end 156 of the cartridge 29. This provides the desired hyperbolic shape to the strips 24 between the webs 22 on the cylindrical blank as described above. With the rotatable tool 158 is held in the rotated position, the end portion of the cylindrical portion 162 of the holder 164 surrounding the second end section 176 of the bore 160 is subjected to a swaging operation which deforms the end portion of the cylindrical portion 162 and decreases its inner diameter to bring the inner diameter of the end portion of the cylindrical portion 162 into tight, close fitting engagement over the tabs 26 at the first end 150 of the outer sleeve 28 so that the tabs 26 are tightly held between and in contact with the outer surface of the sleeve 28 and the inner surface of the bore 160. The rotatable tool 158 is then withdrawn along with the first housing 152 leaving the completed connector denoted by reference number 180 in FIG. 25.

As described above, a terminal 172 carrying an electrical conductor 173 may be securely attached to the aperture 168 in the support 166 of the holder 164 by means of a threaded fastener or screw 170. Alternately, the holder 166 and the terminal 172 can be a unitary one piece member like the holder 62. An elongated, cylindrical pin 182 may be releasably inserted into the interior of the barrel socket 184 to couple the electrical device or circuit to which the pin 182 is attached with the circuit or conductors or electrical device to which the conductor 173 and terminal 172 are connected via the socket 184 and the holder 164.

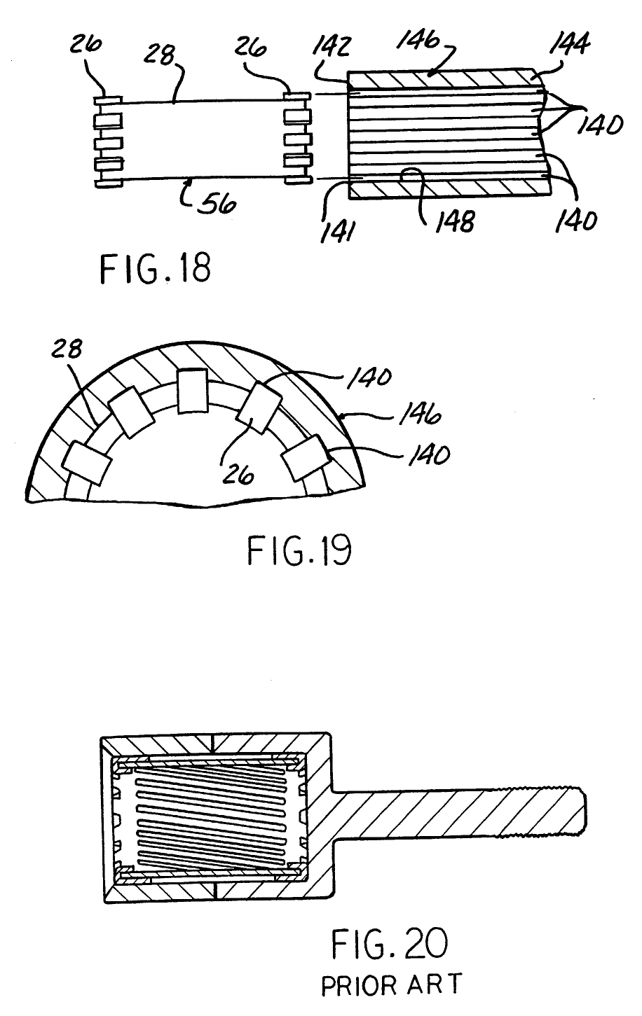

In an alternate construction method, the bore 160 can be formed with grooves 140 as in FIG. 18.

In yet another method, the bore 160 is smooth, but sized for a press fit with the tabs 26. The cartridge 29 initially is inserted half way into the bore 160. Next, the tool 158 is rotated 15° to 45° to offset the tabs 26 and one end of the internal strips from the opposed tabs and the opposite end of the strips. The tool 158 then axially advances pushing the cartridge 29 fully into the bore 160 whereby the tabs 26 at both ends of the cartridge 29 are held in the angularly offset position through a press fit with the inner surface of the bore 160.

Referring now to FIGS. 11-17 there are depicted alternate embodiments of a holder, support or use device which can incorporate the barrel socket 56 or described above.

In FIG. 11, a holder 82 is shown in which a hollow cylindrical member 84 projects generally perpendicularly from one end of a planar support 86. The barrel socket 56 tightly mounted within the hollow bore of the cylindrical portion 84 of the holder 82. The opposite end of the planar member 86 includes two pairs of bendable collar members 88 which can be bent and tightly crimped about an electrical conductor or cable inserted therein.

In FIG. 12, the barrel socket 56 is mounted in one end of a cylindrical portion 90. The cylindrical portion 90 is at one end of a holder 92 which has a generally planar flange 94 at an opposite end carrying an aperture 96 for receiving a threaded fastener to mount the holder 92 to a use device, support, etc., not shown.

In FIG. 13, the barrel socket 56 is mounted in a cylindrical sleeve 98. A U-shaped assembly 100 projects from one end of the cylindrical sleeve and is capable of mounting to a support or for receiving an electrical conductor therein.

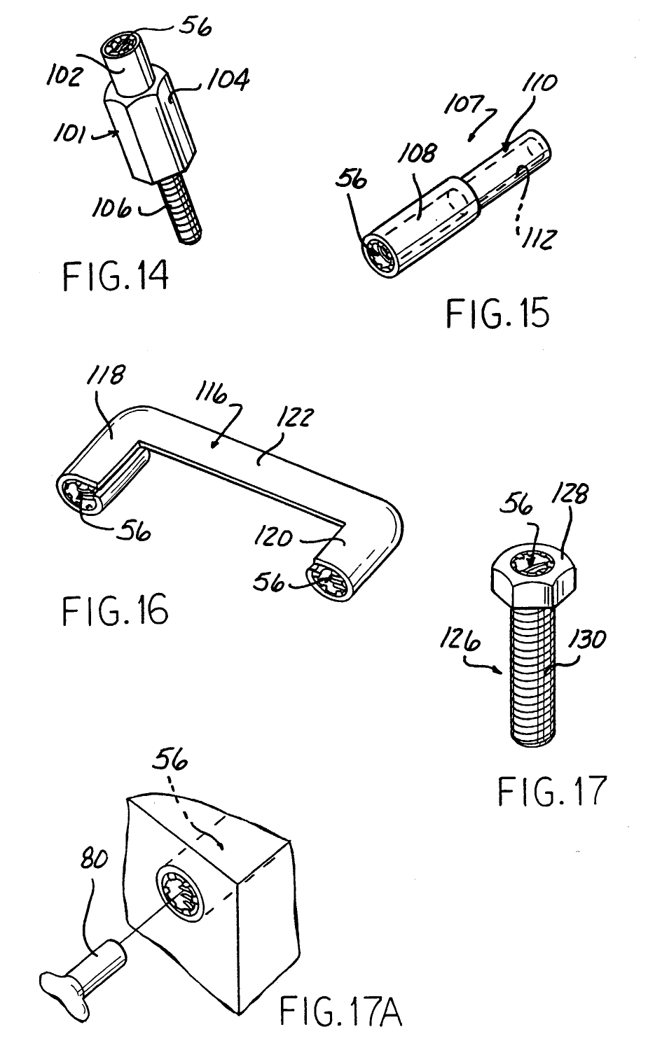

In FIG. 14, the barrel socket 56 is mounted in a cylindrical sleeve 102 having one end extending outward from a hex-head nut 104. A threaded shank 106 projects from the opposite end of the nut 104 for mounting the nut and the barrel socket 56 in a use device.

In FIG. 15, the barrel socket 56 is mounted in a cylindrical sleeve 108 having a different diameter cylindrical sleeve 110 at an opposite end. A hollow bore 112 projects from an open end of the cylindrical sleeve 110. The bore 112 is smooth or threaded and sized to receive a pin, plug or electrical conductor to interconnect the electrical device, electrical conductor or cable attached to a similar pin 80 insertable into the barrel socket 56.

In FIG. 16, a holder 116 in the form of a U-shaped member is provided with cylindrical sleeves 118 and 120 at opposite ends which project generally angularly or perpendicularly from a rigid or flexible central leg 122. The cylindrical portions 118 and 120, while being capable of comprising a continuous side wall, cylindrical, tubular member, are illustrated in FIG. 13, by way of example only, as comprising a circular formed flange having opposed spaced ends. One barrel socket 56 is mounted in each cylindrical sleeve 118 and 120 to interconnect pins in the associated conductor, electrical use device, etc., attached to the pins, to each other via the barrel sockets 56 in the cylindrical sleeves 118 and 120 and the leg 122 of the holder 116.

In the embodiment shown in FIG. 17, the barrel socket 56 is mounted within a bore formed through a large diameter bolt having a hex-shaped nut head end 128 and an elongated, threaded shank 130. The holder 126 may thus be threadingly engaged into a threaded bore in an electrical use device, not shown.

It should be noted that in all of the embodiments described above, all of the holders 82, 92, 97, 101, 107, 116 and 126 are electrically conductive and formed of a suitable electrically conductive material, such as copper, copper alloy, etc.

FIG. 17A depicts a barrel socket 56, constructed as described above, mounted in a electrical use device, such as a battery, alternator, etc.

Referring now to FIGS. 18 and 19, there is depicted another aspect or embodiment of the present invention which includes a plurality of elongated splines or grooves 140 which extend longitudinally between opposite ends 142 and 144 of a use device, holder or support 146.

It will be understood that although the holder 146 is depicted as being a separate, stand alone element, the entire structure of the holder 146 may be incorporated into a larger electrical use device, such as an alternator, battery, etc. without the use of a separate external cylindrical sleeve containing the splines or grooves 140. In this case, the splines or grooves 140 may be simply formed in a suitably sized bore in the use device.

Further, in FIG. 18, the barrel socket 56 is depicted without the surrounding first and second holders 30 and 40 which are required to hold the tabs 26 in the folded over, clamped position in engagement with the outer surface of the sleeve 28 prior to insertion into the bore 148 in the holder 146.

The grooves or splines 140 have a generally square cross section sized to non-rotatably receive the folded over tabs 26 at each end of the barrel socket 56 when the pusher 74 pushes the barrel socket 56 from the aligned first and second housings 30 and 40. Although the tabs 26 at one end of the barrel socket 56 are angularly, rotatably offset from the originally coaxial tabs 26 at the opposite end of the sleeve 28, the first set of tabs 26 are rotated sufficiently to bring the tabs 26 at the opposite end of the sleeve 28 into coaxial alignment. This ensures that the tabs 26 at each end of the barrel socket 56 are engage able with the grooves or splines 140 in the holder 146.

The forward ends of the splines 140 can be provided with an outwardly tapered edge 141 to guide the tabs 26 into one of the splines 140 as shown in FIG. 18. The grooves or splines 140 resist movement of the rotatably offset tabs 26 at either end of the sleeve 28. In addition, the inner surface diameter of the grooves or splines 140 are sized for a press fit with the tabs 26 or can be swaged into a press fit with the tabs 26 to retain the barrel socket 56 in the holder 146 or use device.

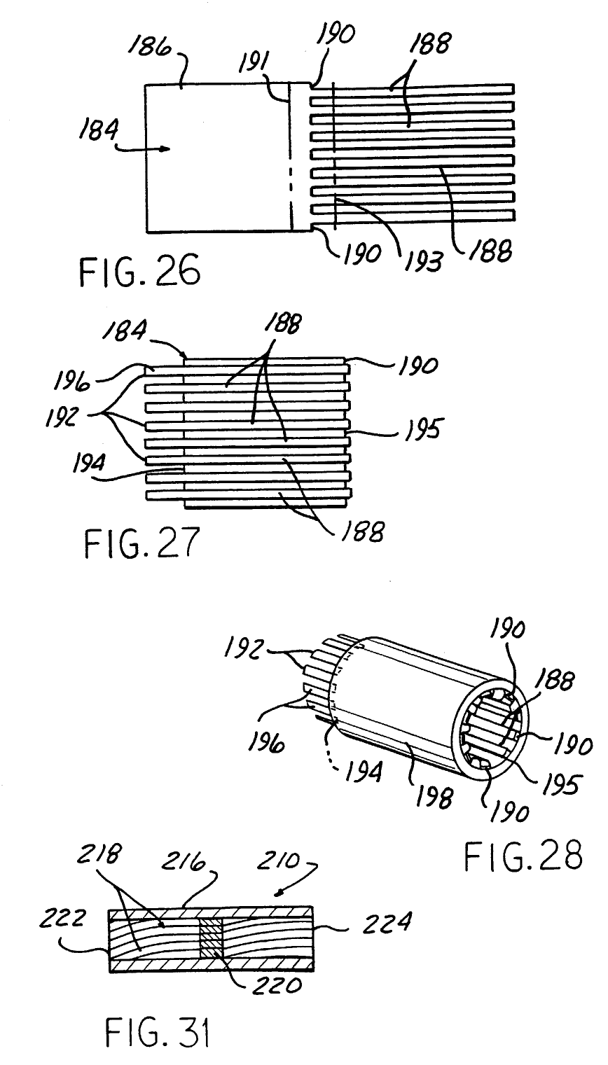

An alternate method of constructing the blank 20 and outer sleeve 28 described above and shown in FIGS. 1-4 as a unitary, one piece member is depicted in FIGS. 26-28.

In this aspect of the present invention, a one piece sheet metal blank 184 is formed with a first generally rectangular, solid end portion 186 and a plurality of elongated, generally flat strips 188 which extend longitudinally from one end of the solid end portion 186 and are equally spaced apart and disposed in parallel. The entire blank 184 may be formed of a suitable electrically conductive material, such as beryllium copper. The strips 188 are unitarily joined to one end of the solid end portion 186 at a first end 190 by welding or as a unitary stamping with the solid portion 186. Alternately, the strips 188 maybe joined to the blank 186 along lines 191 or 193 with suitably formed end portions on the strips 188 or the blank 186.

Next, all of the strips 188 are bent or folded over the second end 195 of the solid end portion 186 about the first end 190 and remain in parallel as shown in FIG. 27. As shown therein, the free ends 192 of each of the strips 188 extend beyond a first end 194 of the solid end portion 186. The portion of the strips 188 projecting beyond the first end 194 form tabs 196.

Next, as shown in FIG. 28, the solid end portion 186 is then folded into a cylindrical sleeve 198 and the edges welded or otherwise fixedly joined together. The folding operation carries the strips 188 overlaying one surface of the solid end portion 186 such that the strips 188 are now disposed within the interior of the resulting cylindrical sleeve 198 as shown in FIG. 28. The tabs 196 still project outward beyond the first end 194 of the sleeve 198.

At this point in the construction of the sleeve 198, the second end 195 may be inserted into tight engagement with a bore in a holder, as described above. The tabs 196 may be folded over the outer surface of the sleeve 198 and secured in the bore of a holder as described above and shown in FIG. 10, after the angular offset is imparted to one end of the strips 188, by either of the previously described construction methods.

FIG. 29 depicts three different attachment locations or methods for attaching the tabs 196 or an end portion of the tabs 196 or the strips 188 to the outer sleeve 198. All three are depicted in a single sleeve 198 merely for convenience, it being understood that in an actual construction, one or more of the attachment methods could be employed for all of the strips 188 and tabs 196 in a single connector.

The different attachment methods share a common feature in that the tabs 196 or end portions of the strips 188 are fixedly secured to the sleeve 198 by welds. Since the weld cannot increase the thickness of the tab 196 or strip 188, a slight depression or aperture 200 can be formed at the end portion of the tabs 196 or strips 188 at the location of each weld.

Thus, according to one aspect of the invention, the tabs 196 are folded over the first end 194 of the sleeve 198 as in the above described embodiments of the invention and then welded to the outer surface of the sleeve 198. Alternately, the tabs 196 can be shortened so as to define a portion 202 which has a length only foldable over the first end 194 of the sleeve 198.

According to another aspect of the present invention, the strips 188 are formed without any tabs 196 such that the strips 188 terminate in an end 204 within the bore in the sleeve 198 adjacent to the first end 194 of the sleeve 198.

Regardless of which construction technique is employed, the end result is that the strips 188 are maintained in parallel at the first end 194 of the sleeve 198 and fixedly secured thereto after the freely movable end portions of the strips 188 at the first end 194 of the sleeve 198 have been rotated the desired amount as in the construction methods described above.

Rather than fixedly attaching the ends of the strips 188 or the tabs 196 at the end of the strips 188 to the sleeve 198, an annular collar or outer barrel may be employed as described in the patents incorporated herein by reference to securely maintain the folded over tabs 196 in a fixed, rotated position with respect to the opposite ends of the strips 188.

It is also possible in the construction shown in FIG. 26 to construct the strips 188 of a different conductive material than the material forming the solid end portion 186. In this manner, the solid end portion 186 which forms the cylindrical sleeve 198 may be formed of a lower cost material, such as brass; while the strips 188 which form the main contact area of the socket, are formed of a more suitable electrically conductive material, such as beryllium copper. In such a construction, the first ends 190 of the strips 188, or alternately, the ends at lines 191 and 193, are securely fixed to the end 195 of the solid end portion 186, preferably by welding the end of each strip 188 to the end of the solid end portion 186.

The use of individual strips 188 which are then fixedly secured to the solid end portion 186 also can be used to reduce manufacturing costs by eliminating the scrap normally associated with stamping the blank 20 or the blank 184 as described above from a single sheet. The individual strips 188 can be formed of flattened wire thereby eliminating scrap in forming the unitary sleeve 198 and the strips 188.

This aspect of the present invention also reduces part count in constructing the sockets since the cylindrical sleeve and strips can be unitarily formed as a one piece member thereby eliminating the need for a separate sleeve and a separate blank carrying the contact strips and end tabs.

FIG. 30 depicts a modification to the blank 184 shown in FIG. 26. In this aspect of the present invention, the solid end portion 186 of the blank 184 is formed with two unitary tabs 206 which project outwardly from opposite side edges of the solid end portion 186. Each tab includes an aperture 208. When the solid end portion 186 is formed into the cylindrical sleeve 198, the tabs 206 will be brought into overlaying engagement, with the apertures 208 in each tab 206 aligned for receiving a fastener there through. This forms an integral terminal for attaching the completed socket to a support or use device.

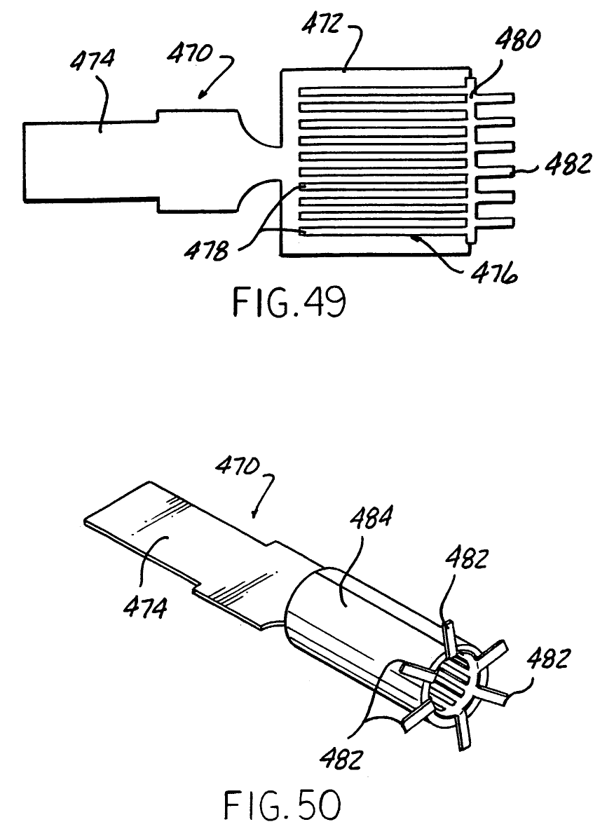

Referring now to FIGS. 49 and 50, there is depicted a modification to the blanks and contact members described above and shown in FIGS. 26-30. As shown in FIGS. 49 and 50, a connector 470 is initially formed with a generally planar blank 472 which may optionally have an elongated terminal 474 projecting therefrom. A contact member or assembly 476 is mounted on the blank 472. In this aspect of the invention, the contact member 476 is in the form of a plurality of thin contact strips 478 which are fixedly secured at one end to the blank 472, such as by welding, for example. The other end of each of the strips 478 is unitarily formed with a transversely extending web 480. A plurality of tabs 482 project outwardly from the web 480. The number of contact strips 478 and the number of tabs 482 may be varied depending upon the required size for the connector 470 or the required current carrying capability.

In this manner, the end of the contact member 476 which contains tabs 482, the web 480 and one end of the contact strips 478 is cantilevered or freely movable with respect to the opposed fixed ends of the strips 478.

In completing the connector 470, the blank 472 is formed or bent into a cylindrical sleeve 484 with the lateral edges of the blank 472 disposed in close abutment. The transverse ends of the blank 472 may be mechanically secured to each other by means of welds, interlocking projection and apertures, etc. However, for small diameter connectors, the walls of the cylindrical sleeve 484 made from the blank 472 will have sufficient strength to remain in close proximity thereby retaining the cylindrical shape of the sleeve.

When the blank 472 has been formed to the cylindrical sleeve 484 shown in FIG. 50, the tabs 482 project outwardly from one end of the sleeve. The tabs 482 are then bent radially outward to the position shown in FIG. 50 or even further over the exterior surface of the sleeve 484 in the same manner as described above and shown in FIGS. 4-8 and 21, 22. A tool, such as the tool shown in FIG. 22 may then be brought into engagement with the tabs 482 and then rotated to apply an angular offset to the tabs 482 and the adjacent ends of the contact strips 478. This angularly offsets the ends of the contact strips 478 connected to the web 480 from the opposite ends of the strips 478 fixed interiorly within the sleeve 484 to thereby cause the intermediate portions of strips 478 to assume a hyperbolic shape suitable for secure electrical engagement with a conductive member or pin insertable into the sleeve 484.

At the same time, the connector 470, when slid into a holder or electrical use element, not shown, will have the tabs 482 forcibly bent over the end of the sleeve 484 and into tight fitting contact with the exterior surface of the sleeve 484 and the adjacent interior wall of the bore in the holder or use element thereby retaining the tabs 482 and the adjacent end of the contact strips 478 in the angular offset position relative to the opposed fixed ends of the contact strips 478.

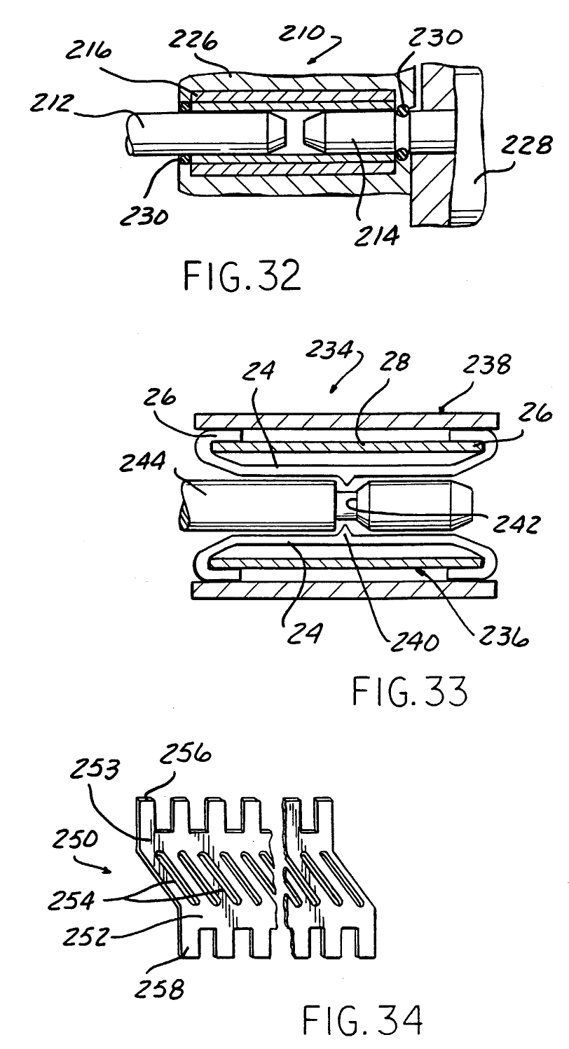

Referring now to FIGS. 31-32, there is depicted another aspect of the electrical connector of the present invention in which a connector 210 operates as a quick connector allowing easy disconnect of one or more pins 212 and 214 from the connector 210.

In this aspect of the invention, a cylindrical sleeve 216 having an elongated length, typically twice as long as the outer sleeve 28 described above, may be constructed according to either of the methods also described above. Prior to forming a rectangular blank into a cylindrical sleeve, a plurality of thin strips or flatten wires 218 are overlaid over the blank and securely fastened to the blank at an intermediate portion of each strip 218 by welding, preferably ultrasonic welding. Since the center portion 220 of each strip 218 is fixed and non-movable, the opposed free ends 222 and 224 of each strip 218 now act as individual strips with respect to the fixed center point 220. When the blank is formed into the cylindrical sleeve 216, a rotatable tool, such as the rotatable tool 50 shown in FIG. 7 may be inserted into both ends of the sleeve 216 and rotated a predetermined amount, such as 15° to 45°, to provide the desired twist or angular displacement of the outer ends 222 and 224 of the individual strips with respect to the fixed center point 220 of each strip. After angularly displacing the outer ends 222 and 224 of each strip section, the outer ends are fixed in position with respect to the sleeve 216 by any of the methods described above, such as by bending the tab ends of each strip 218 around and into face-to-face contact with the outer surface of the sleeve 216 prior to forcibly fitting the sleeve 216 into a surrounding holder 226 as shown in FIG. 32. Alternately, as shown in FIGS. 31 and 32, the ends 222 and 224 of each strip section 218 can be welded to the inside edge of the bore in the sleeve 216 adjacent each outer end of the sleeve 216 or the end surface or the outer surface as shown in FIG. 29.

In a quick connector application, a pin 214 is fixedly mounted in a holder or support 228 attached to a use device, not shown. An optional seal, such as an O-ring 230 is interposed between the sleeve 216 and the holder 228. Likewise, an optional seal, such an O-ring 230, is interposed at the opposite end of the sleeve 216 at the opening to the bore in the sleeve 216.

The pin 212 may be removable engagable in the sleeve 216 in contact with the strips 218 to thereby provide a connection to the electrical device attached to the pin 212 through the connector 210 to the use device to which the pin 214 is electrically connected.

FIG. 33 depicts yet another aspect of the present invention in which a connector 234 includes a barrel socket 236 fixedly mounted in a holder 238. By example only, the socket 236 is identical to the socket described above and shown in FIG. 10.

In this aspect, the strips 24 extending between the opposing webs and tabs 26 are provided with a generally intermediately disposed projection 240 which projects radially inward into the bore formed in the cylindrical blank. The projection 240 on each strip 24 is adapted to slidably engage a recess 242 formed in a pin 244 which is removably insertable in the bore of the socket 234. The projection 240 and recess 242 form a detent which provides an indication of full insertion of the pin 244 into the barrel socket 236. At the same time, the projection 240 resists separation from the recess 242 due to forces acting in the direction to disengage the pin 244 from the socket 236 thereby increasing the pullout force retaining the pin 244 in the socket 236.

FIG. 34 depicts a modified blank 250 which may be employed in the barrel socket disclosed above and shown in FIGS. 1-10. The blank 250 is similarly formed as the blank 20 in that it includes opposed webs 252 between which extend a plurality of parallel strips 254. End tabs 256 and 258 project outward from opposite ends of each web 252.

As compared to the blank 20 shown in FIG. 1 in which the tabs 26 are axially aligned with the strips 24, in the blank 250, an angular offset or partial helix is formed between the webs 252 and 253 such that the individual strips 254 which extend between the tabs 256 and 258 are disposed at an angle from a longitudinal axis of the cylindrical sleeve in which the blank 250 is mounted. Although the amount of the angular offset can be varied, a 45° angle is shown by way of example only.

After the blank 250 is formed into a cylinder, with the sleeve 28 disposed there over, the angular offset between the tabs 256 and 258 remains thereby placing the strips 254 at an angle between the tabs 256 and 258 prior to further rotation of one end set of tabs, such as the tabs 258, to provide a typical 15° to 45° rotation to one end of the cylindrically form blank 250. The angle preformed in the blank 250 for the strips 254 provides a greater attack angle of the hyperbolic strips 254 from the longitudinal axis of the socket and, more importantly, significantly increases the contact area of each strip 254 with a pin inserted into the barrel socket.

It should be noted that the blank 250 may be used in any barrel socket construction disclosed herein as well as in the barrel sockets disclosed in U.S. Pat. Nos. 4,657,335 and 4,734,063, which have end collars or outer barrels fixedly joining the folded tabs to the outer surface of the sleeve.

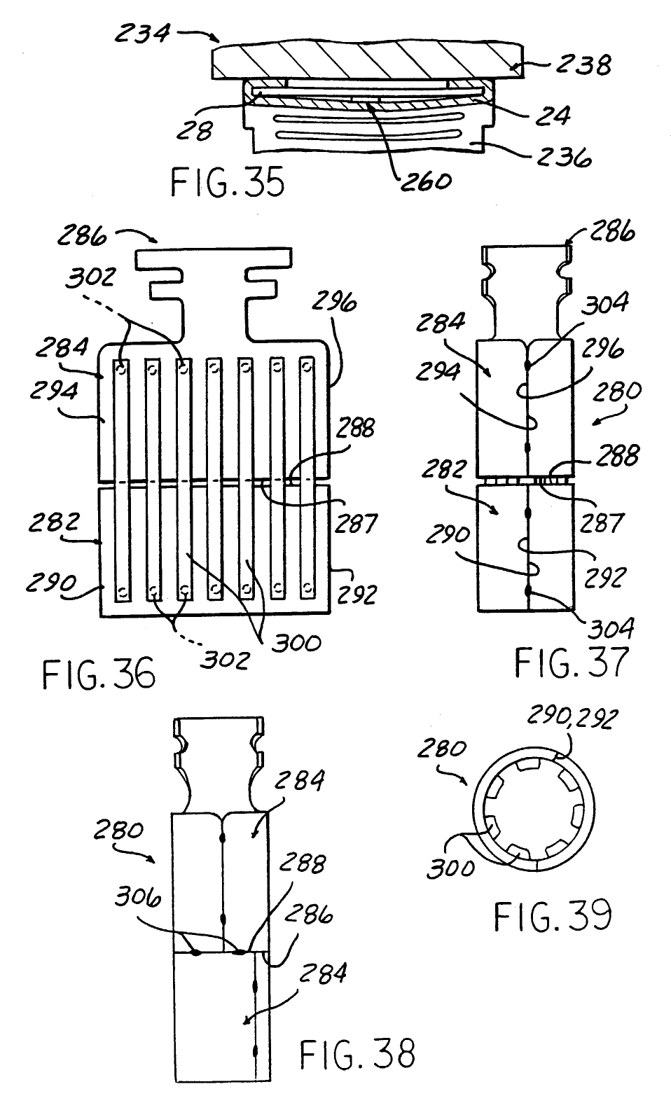

Finally, FIG. 35 depicts a further aspect of the barrel socket shown in FIG. 1 or any barrel socket utilizing radially resilient contacts formed by any of the methods of the present invention discussed above or in U.S. Pat. Nos. 4,657,335 and 4,734,063.

For convenience, the modification shown in FIG. 35 is applied to the connector 234 and barrel socket 236 shown in FIG. 33. Identical reference numbers in both embodiments are used in both FIGS. 33 and 35 to depict like parts.

In this aspect of the present invention, an annular projection 260 is formed between the sleeve 28 and each strip 24 on the contact member of the barrel socket 236. The annular projection 260 is preferably in the form of a resilient or elastomeric band which can be attached by suitable means, such as by an adhesive, to either the strips 24 or the sleeve 28 generally intermediate the opposed ends of the strips 24 and sleeve 28. The band 260 biases the center point of each strip 24 radially inward into the bore of the barrel socket 236 to provide back pressure on the contact area of the grid or strips 24 for secure electrical contact with a pin inserted into the barrel socket 236.

Referring now to FIGS. 36-39, there is depicted another embodiment of a connector 280 according to the present invention. The connector 280 is also in the form of a barrel socket and, as shown in FIG. 36, is formed of a blank constructed of two sections or portions, such as a first blank 282 and a second blank 284. Both of the blanks 282 and 284 have a generally polygonal cross-section of any dimension depending upon the application of the connector 280. Further the blanks 282 and 284 are formed of a suitable electrically conductive material, such as brass, copper, etc. By example only, one of the blanks such as blank 284, has an end formed in the terminal portion 286 which originally formed as a flattened extension of one end of the blank 284.

The blanks 282 and 284 are disposed in an end-to-end arrangement with a small gap between ends 287 and 288, respectively. The opposed side edges of each blank 282 and 284, such as side edges 290 and 292 for the blank 282 and side edges 294 and 296 for the blank 284 are disposed opposite from each other, but in the aligned pairs as shown in FIG. 36.

A plurality of electrically conductive contact strips 300 are individually placed over the aligned blanks 282 and 284 and are equidistantly spaced apart as shown in FIG. 36. The contact strips 300 may have any cross-section, such as circular, polygonal, with a generally rectangular cross-section being shown in FIGS. 36 and 39 by way of example only. The cross-sectional size of each contact strip 300 will determine the amperage which can be carried by connector 280. By example only, each contact strip 300 is formed of beryllium copper.

The contact strips 300 are aligned in parallel along a longitudinal axis of the blanks 282 and 284. Opposed ends of each contact strip 300 are secured to the blanks 282 and 284, preferably by welds 302, to secure one end of each contact strip 300 to the blank 282 and the opposed end of each contact strip 300 to the blank 284.

In the next step of constructing the connector 280, the blanks 282 and 284, are formed or bent into cylinders as shown in FIG. 37. In this cylindrical arrangement, the opposed side edges of each blank 282 and 284, such as the side edges 290 and 292 of the blank 282 and the side edges 294 and 296 with the blank 284 are brought into an abutting relationship. The abutting side edges of each blank 282 and 284 are then secured together, such as by welds 304 shown by example only in FIG. 37 or by other securing means, such as mechanical interlocking tabs and mating slots, etc.

It will also be noticed in FIG. 37 that the cylindrical formation of the blank 284 also causes the opposed side edges of the terminal end 286 unitarily extending from the blank 284 to be formed into perpendicular sides from a central base suitable for acting as a wire crimp terminal or other mounting device.

In the next step of constructing the connector 280, one of the cylindrically formed blanks 282 and 284 is held stationary and the other blank 282 or 284 is rotated along a longitudinal axis extending through the coaxially aligned blanks 282 and 284, to offset one end of each contact strips 300 from the opposed end of each contact strip 300 so as to form the contact strip 300 in a hyperbolic shape between the opposed ends. By example only, FIG. 38 depicts the angular rotation of the blank 282 relative to a stationary position of the blank 284 by a predetermined angular amount, such as, for about 45° by example only. This angular rotation also brings the ends 286 and 288 into abutting contact through twisting the strips into a shortened hyperbolic shape.

The blanks 282 and 284 are then fixedly joined together, in the angularly offset position by suitable means, such as by a plurality of welds 306 about the circumference of the abutting edges 286 and 288 of the blanks 282 and 284. A continuous weld about the entire circumference of the mating ends of the blanks 282 and 284 is also possible if high amount of conductivity is required for a particular connector application.

The connector 280, described above and shown in FIGS. 36-39, can be constructed with a small outer diameter since all of the connections between the contact strips 300 and the blanks 282 and 284 are disposed inside of the cylindrically formed blanks 282 and 284.

Further, the cross-sectional size and shape of each of the contact strips 300 may be altered to provide any desired amount of amperage for the application in which the connector 280 is to be used. In addition, since the contact strips 300 are individually formed, material losses resulting from stamped contact strips which are held together by webs at opposed ends are eliminated.

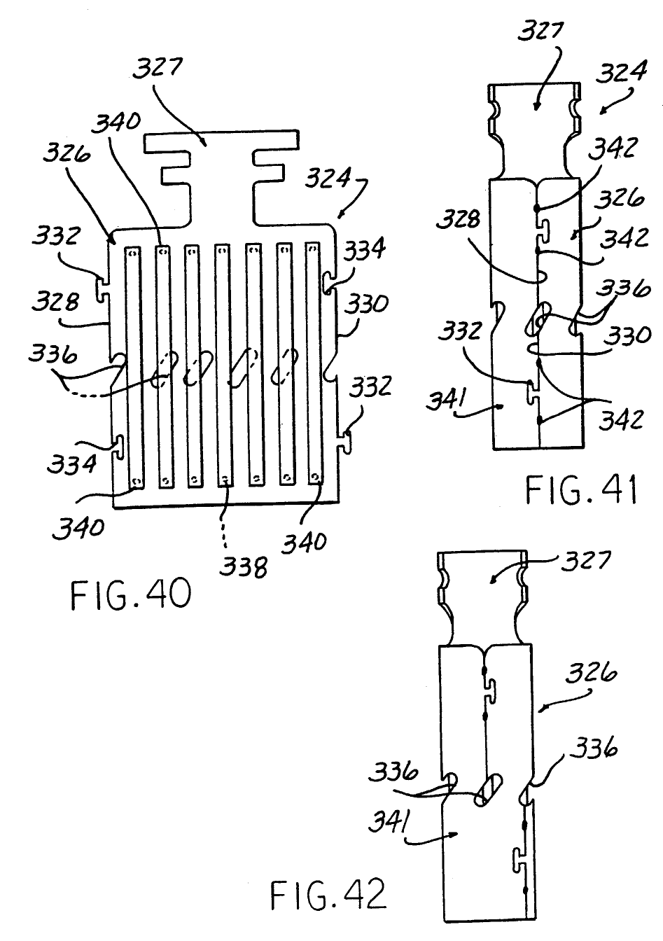

Referring now to FIGS. 40-42, there is depicted another embodiment of a connector 324 which is similar to the connector 280, but has a one piece blank 326. The blank 326 is formed, preferably by stamping, into a generally polygonal shape in which opposed side edges 328 and 330 are formed with mating projections 332 and apertures 334. As shown in FIG. 41, the projections 332 and apertures 334 alternate on opposite side edges of the blank 326.

A plurality of apertures, such as elongated slots 336, are formed intermediately between opposed ends of the blank 326. The slots 336 are spaced apart across the width of the blank 326 and are angularly offset from a longitudinal axis of the blank 326.

A plurality of contact strips 338, identical to the contact strips 300 described and shown above in FIG. 36, are spaced apart and in parallel along the longitudinal extent of the blank 326. Each contact strip 338 is fixedly secured to the blank 326 at opposed ends by welds 340.

The blank 326 is then formed or bent into a cylindrically shaped sleeve 341 shown in FIG. 42 with the mating projections 332 and slots 334 interlocked to hold the blank 326 in the desired cylindrical shape. Welds 342 may alternately be formed along the length of the mating side edges 328 and 330 of the blank 326 to assist in maintaining the blank 326 in the shape of the cylindrical sleeve 341.

Next, one end of the sleeve 341 is held stationary and the opposed end is rotated through a predetermined angle, such as by about 45°, to provide the desired hyperbolic shape between the opposed fixed ends of the contact strips 338. This angular rotation causes the slots 336 to move axially in-line with the longitudinal axis of the sleeve 341 as shown in FIG. 42.

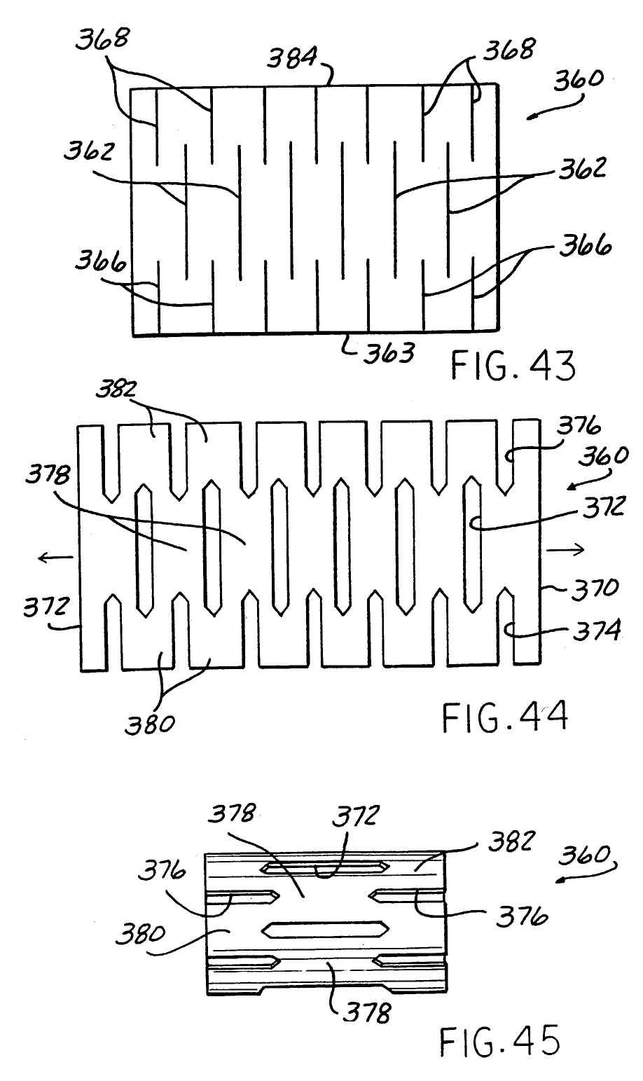

Referring now to FIGS. 43-45, there is depicted another embodiment of a contact grid 360 which may be employed in any of the connectors described above.

In this embodiment, the grid 360 is formed of any suitable conductive material, such as brass, copper, etc. Further, the grid 360 is provided in a polygonal shape which will eventually formed in a cylindrical cross-section as in the previously described connectors.

In the first step of forming the grid 360 into a connector, the flat grid blank 360 is sheared in a die or press to form a plurality of slits in a predetermined arrangement as shown in FIG. 43.

A plurality of groups of slits including a first group of centrally disposed slits 362 having opposed ends spaced from the opposed side edges 363 and 364 of the grid blank 360. The slits 362 are disposed in parallel and equidistantly spaced apart. Between the opposed ends of each slit 362, a pair of end slits 366 and 368 are also formed in a second group of slits in the grid 360. The end slits 366 extend inward from side edge 363 of the grid 360 to an inner end spaced inward from one end of the adjacent center slits 362. The opposed end slit 368 extends inward from the opposed side edge 364 of the grid 360 to an inner end also spaced inward from the opposed end of the adjacent center slits 362. One end slit 366 and one end slit 368 are arranged in axial pairs with the inner ends spaced apart by a solid portion of the grid 360.

Next, as shown in FIG. 44, the grid 360 formed with the slits 362, 366 and 368 is subjected to an expansion force along one end 370 or in opposite directions with respect to both ends 370 and 372 as shown by the arrows in FIG. 44. The grid 360 is expanded a predetermined amount to allow spring back so as to form each slit 362, 366 and 368 into a slot 372, 374 or 376 of a predetermined width as shown in FIG. 45. The slots 372, 374, and 376 will have approximately the same width.

After expansion, the grid 360 also includes centrally disposed contact strips 378 which function in the same manner as any contact strips described above in the various connectors according to the present invention. Tabs 380 and 382 are formed between the slots 374 and 376, respectively, on both side ends of the grid 360. The tabs 380 and 382 function in the same manner as any of the tabs described above in certain embodiments of the connector according to the present invention. As shown in FIG. 45, the blank 360 is then formed or rolled into a cylindrical shape.

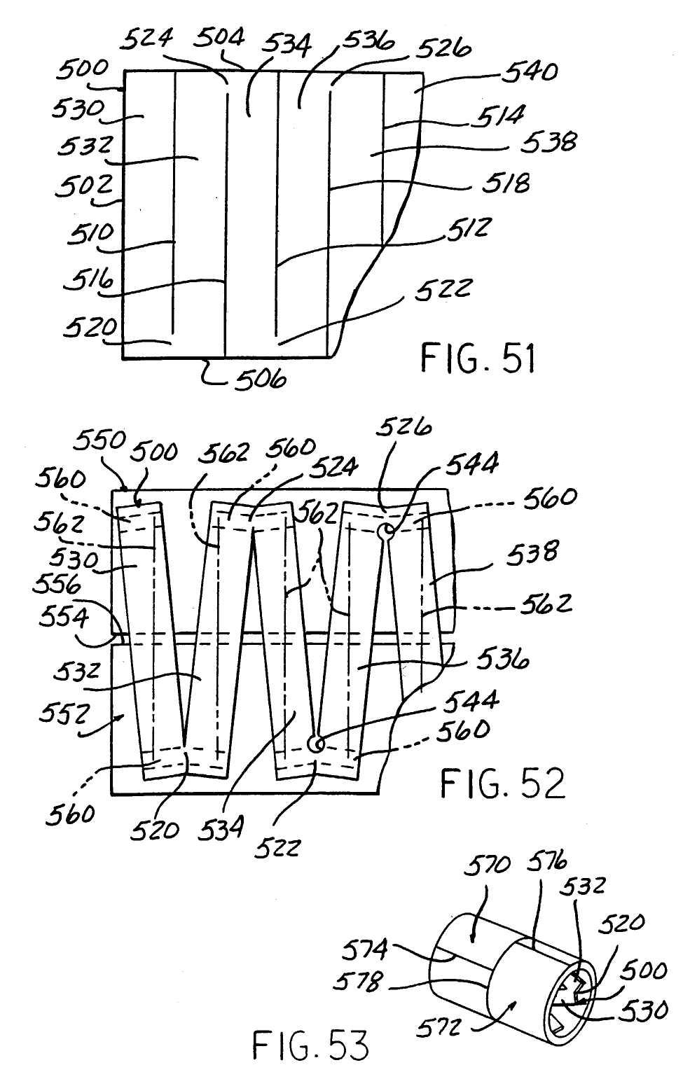

Referring now to FIGS. 51-53, there is depicted another aspect of the present connector. A contact member 500 is shown in an initial manufacturing state in FIG. 51. The contact member 500 is formed of an electrically conductive material, such as copper, etc. The contact member 500 is generally in an elongated strip form with opposed side edges, with only one side edge 502 being depicted in FIG. 51, and opposed lateral edges 504 and 506.

A plurality of slits are sheared or otherwise formed in the contact member 500. The slits are arranged in two groups, with the slits of each of the two groups being disposed in an alternating manner. Thus, a first group of slits 510, 512, 514, etc., are formed in contact member 500 and extend completely from one lateral end 504 toward the opposite lateral end 506, but end a short distance away from the opposed lateral end 506 as shown in FIG. 50.

The second group of slits include slits 516, 518, etc. Each of the second group of slits 516, 518, etc., extends from the lateral end 506 toward the opposite lateral end 504, but ends a short distance from the opposed lateral end 504. The short distance between the ends of the slits 510, 512, etc., forms a section of solid metal denoted by reference numbers 520 and 522 adjacent the lateral end 506 of the contact member 500. Similarly, the short spacing between the ends of the slits 516, 518, etc., and the other lateral end 504 leaves areas of solid metal denoted by reference numbers 524 and 526. It should also be seen that the areas of solid metal 520, 522, 524, and 526 connect individual strips 530, 532, 534, 536, 538, and 540 into a continuous, zig-zag shaped conductive element along the length of the contact member 500. The width of each of the strips 530, 532, 534, etc., is selected based on the number of individual strips needed for the inside diameter of a barrel or outer sleeve as shown hereafter.

As optionally shown in FIG. 52, apertures in the form of small holes 544 may be formed at the ends of each of the strips at the point where the strips end adjacent one of the solid metal portions 520, 522, etc., on the contact member 500. The apertures 544 ease the cross-width slitting process and enable greater expansion of the contact member 500. However, it will be understood that the use of the apertures 544 is only optional and is described and illustrated herein only by way of example.

Next, the contact member 500 is subjected to elongation forces along a longitudinal axis causing the contact member 500 to expand along the individual slits 510, 516, 512, 518, 514, etc., to the generally zig-zag shape shown in FIG. 52. The solid metal portions 520, 522, 524, 526, etc., interconnect two angularly disposed strips, such as adjacent ends of the strips 530 and 532, by the solid metal portion 520. The opposite end of the strip 532 and one end of strip 534 by the solid metal portion 524, the other end of strip 534 and one end of strip 536 by the solid portion 522, and the other end of strip 536 and one end of strip 538 by the solid portion 526.

The continuous, but angularly expanded contact member 500 is then overlaid on two electrically conductive blanks 550 and 552 which are spaced apart at opposed, facing edges 554 and 556, respectively, by a short gap in much the same manner as the two blanks 282 and 284 are spaced apart in the connector shown in FIG. 36. The ends of each of the strips 530, 532, etc., are then fixedly secured in electrical contact with each of the blanks 550 and 552.

Preferably, the ends of each of the strips 530, 532, etc., are fixedly secured to the blanks 550, 552 by welding, with a generally elongated, bar-like weld 560 formed at each end of the strips 530, 532, etc. The amount of weld formed at the end at each of the strips 530, 532, etc., is selected to provide the desired cross sectional contact area between the strips 530, 532, etc., and the blanks 550 and 552 to meet the current carrying requirements of a particular application of the connector. As shown in FIG. 52, it will be understood that although the individual strips 530, 532, etc. The welds 560 form wetted areas which are large enough to carry the required current for the particular application of the connector, are disposed at an angle with respect to a perpendicular line extending between the opposed lateral ends of the blanks 550 and 552, a tensile line 562 extends perpendicularly between the lateral ends of the blanks 550 and 552 generally diagonally along each strip 530, 532, etc. The tensile line defines the contact portion of each strip when the strips are bent into a hyperbolic shape as described hereafter.

After the ends of the strips 530, 532, etc., are securely mounted or welded to the blanks 550 and 552, both of the blanks 550 and 552 are formed or bent into a cylindrical sleeve shape denoted by reference numbers 570 and 572 in FIG. 53. This forms a through bore between the coaxially disposed cylindrical sleeves 570 and 572 which extends parallel to the tensile lines 562 formed in each strip 530, 532, etc. The opposed lateral ends of each blank 550 and 552 are fixedly secured together along a seam 574 and 576, respectively, such as by welds as shown in the connector depicted in FIG. 37. The strips 530, 532, etc., extending between opposite ends welded to the blanks 550 and 552 maintain the opposed faces 554 and 556 of the blanks 550 and 552, respectively, spaced apart by the gap.

Next, as described above for the connector shown in FIGS. 36-39, one sleeve, such as sleeve 570, is held stationary and the other sleeve 572 is angularly rotated, as describe above, a predetermined amount about the axis of the bore through the coaxial sleeves 580 and 572. This forces the strips 530, 532, etc., to assume a hyperbolic shape along the tensile lines 562 between the opposed ends fixedly connected to the interior surfaces of the sleeves 570 and 572 as well as to shorten the gap between the sleeves 570 and 572 until the opposed faces of the sleeves 570 and 572 engage along a seam 578. As in the connector shown in FIGS. 36-39, the two sleeves 570 and 572 may be fixedly joined along the seam 578 by means of welds or other fastening means. This maintains one end of each of the strips 530, 532, etc., angularly offset from the opposed ends of each of the strips 530 and 532 to form the desired hyperbolic shape along the tensile line 562 of each strip 530, 532, etc.

Although this aspect of the connector employing the expanded, continuous, strip-like contact member 500 has been depicted and described as being mounting in an outer sleeve formed of two separate sleeves fixedly joined together, with one sleeve angularly offset about a longitudinal axis in the same manner as shown in the connector depicted in FIGS. 36-39, it will be understood that the expanded contact member 500 may also be employed in the connector shown in FIGS. 40-42 such that the contact member 500 can be mounted on a single blank initially formed with angularly disposed slots in an intermediate portion thereof.

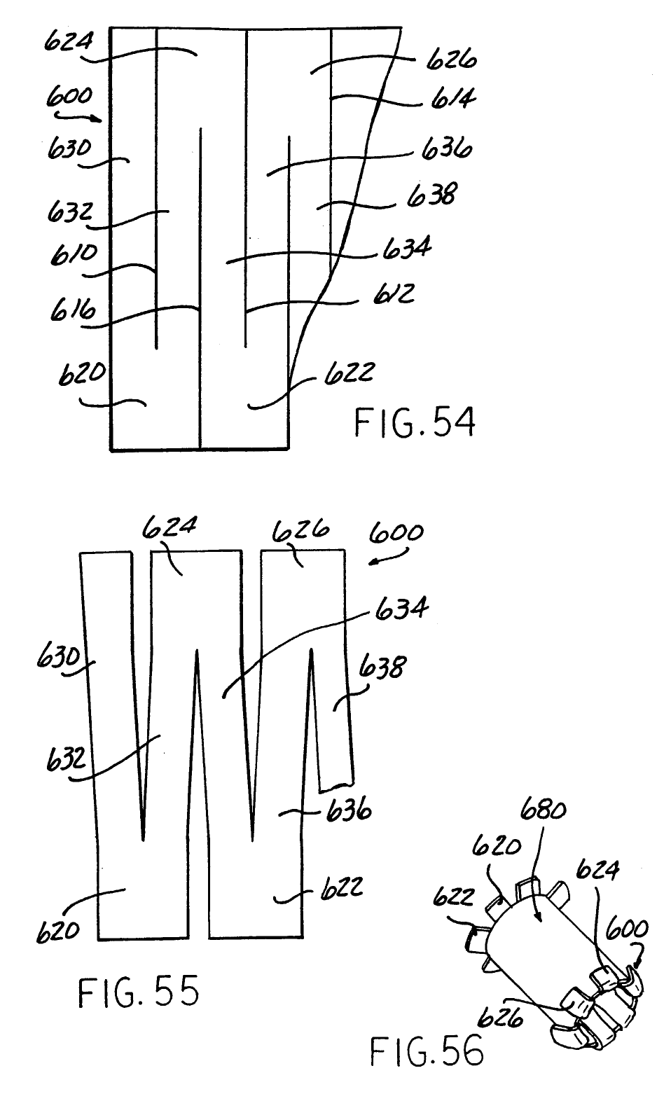

In FIGS. 54, 55 and 56, there is depicted a modification of the connector shown in FIG. 53; but which uses an expanded contact member 600, similar to the contact member 500. Like elements in FIGS. 54-56 and FIGS. 51-53 are differentiated by a 600 series reference number and a 500 series reference number, but with the same units and tens digits.

The contact member 600 is formed with individual slits 610, 616, 612, 618, 614, etc., which form strips 630, 632, 634, 636, 638, etc., which when the contact member 600 is expanded, as described above, separate into a general zig-zag shape as shown in FIG. 55.

With this aspect of the invention, the solid metal end portions or tabs 620, 622, 624, 626, etc. are lengthened from the solid metal portions 520, 522, etc.

This aspect of the invention is amenable for construction in a connector having features shown in FIGS. 1-10 and 21-29 wherein the contact member 600, after expansion, as shown in FIG. 55, is bent or formed into a cylindrical shape and then inserted into a cylindrical sleeve 680 as shown in FIG. 56. The solid metal portions or tabs 620, 622, 624, 626, etc. project axially outward from the ends of the sleeve 680. The tabs 620, 622, 624, 626, 626, etc. are then bent over into contact with the exterior surface of the sleeve 680 by any of the construction methods described above and shown in FIGS. 1-9 and 21-25.

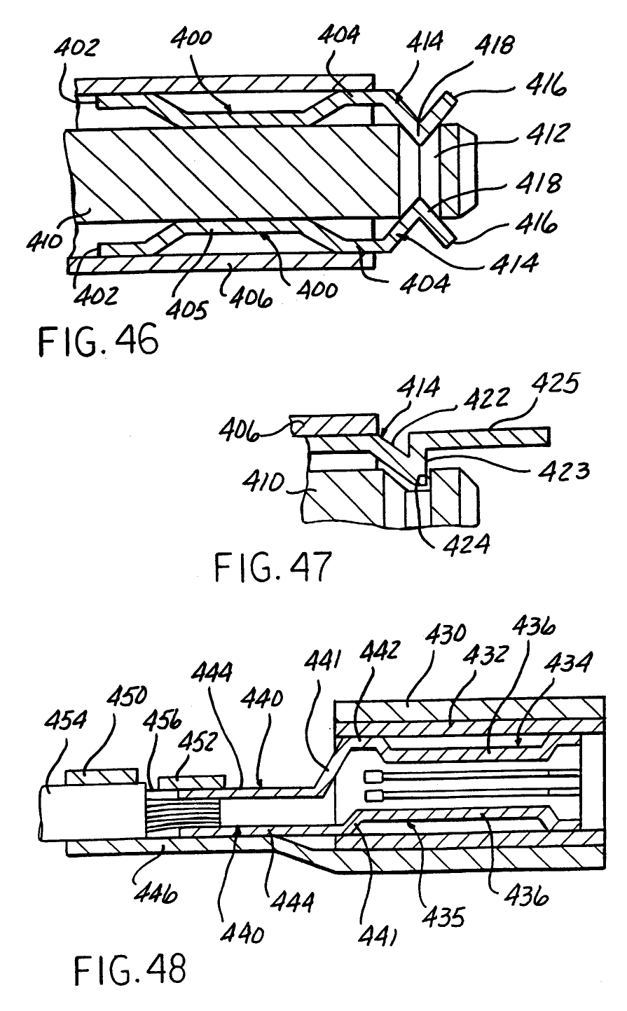

FIG. 46 depicts another aspect of the present connector in which one or more contact strips are modified to form a detent for releasable or non-releasable latching of a connector pin inserted into the bore within the strips in the connector. The connector strips 400, only two of which are illustrated for clarity in FIG. 46, are formed by any of the stamped or welded methods described above in which opposed ends of each contact strip 400, such as ends 402 and 404 are fixedly secured to the outer sleeve 406. One end of each contact strip 400 is angularly offset from the opposed end to form a hyperbolic center portion 405 which extends radially inward into the bore in the outer sleeve 406 for providing secure electrical connection with a conductive pin 410. The pin 410, as described above in the aspect of the invention depicted in FIG. 33, has an annular groove or recess 412 adjacent one end.

In this aspect of the invention, at least one and preferably two or more diametrically opposed contact strips 400 are formed with an extension 414 which has an outer end 416 projecting outward from one end of the sleeve 406. The number of contact strips 400 which are formed with the extension 414 may be varied such that one, two diametrically opposed, or every other contact strip in the connector may be provided with the extension 414 so as to provide varying amounts of insertion and release resistance force as required for the requirements of a particular connector application.

Each extension 414 was formed with a detent 418 which extends radially inward from the adjacent end of the contact strip 400 to releasably engage the recess 412 in the pin 410 upon insertion of the pin 410 completely into the outer sleeve 406. Due to the ability of the end 416 of the extension 414 to move, during insertion of the pin 419, one end of the pin 410 engages the detent 418 and urges the detent 418 radially outward a sufficient distance to cause the innermost edge of the detent 418 to slide across the end surface of the pin 410 until the detent 418 snaps into the recess 412 in the pin 410 to lock the pin 410 in the connector. Due to the generally V-shape of the detent 418 on the respective contact strips 400, and the illustrated corresponding V-shape of the recess 412 in the pin 410, the pin 410 can be removed from the connector by an opposed sliding action in which event, the end portion of the pin 410 will again bias the detent 418 radially outward from the recess 412 in the pin 410 until the pin 410 clears the detent 418.

The detent 418 may take other shapes which provide only a slide-in locking movement of the pin 410 relative to the connector, but which have lower or higher levels of separation resistance of the pin 410 from the connector after locking engagement with the detent(s) 418 on the contact strips 400. As shown in FIG. 47, the detent 422, in another aspect of the invention, is formed as a radially inward angled leg projecting from one end of the extension 418. The detent 422 has an intermediate flat edge 423 and an extension or tabs 425 which projects outward from one end of the sleeve. Radially outward movement of the tab 425 will disengage the detent 422 from the recess 412 to enable separation of the pin 410 from the connector. The recess 412 in the pin 410 is formed with a generally flat edge 424. It can be seen that the operation of the detent 422, upon insertion of the pin 410 in the connector, is the same as that described above and shown in FIG. 46 in that the end of the pin 410 will engage and bias the detent 422 radially outward a sufficient distance to clear the end of the pin 410. Upon continued insertion of the pin 410 into the connector, the detent 422 will snap into the recess 424 on the pin thereby locking the pin 410 in the connector. However, due to the flat edge 423 of the detent 422 and the generally planar surface 424 in the recess 412 in the pin 410, any axially outward movement of the pin 410 will cause the end of the detent 422 to engage the surface 424 thereby preventing separation of the pin 410 from the connector. This forms a one way lock allowing only insertion of the pin 410 into the connector, but preventing separation of the pin 410 from the connector.

It will be understood that other detent shapes may also be used to provide a one way lock as described above. Further, the angle of contact of the detent with the angled or arcuate faces of the recess in the pin 410 may also be varied to provide varying amounts of insertion and removal forces. For example, the detent on the contact strip 400 and the recess 412 in the pin 410 can have the V-shapes respectively varied with different angular amounts to provide a low or easy on insertion force permitting easy insertion of the pin 410 into the connector; but a high force resistance in an opposite direction of movement of the pin 410 relative to the connector.

FIG. 48 depicts yet another modification to one aspect of the connector of the present invention in which a contact member having a plurality of individual contact strips may be formed according to any of the methods described above and mounted in a terminal 429, similar to the terminal or holder 62 shown in FIGS. 9 and 10. As described above, the terminal 429 has a cylindrical end portion 430 which receives a cartridge constructed according to the present invention formed of an outer sleeve 432 and a plurality of contact strips 434 disposed therein. One end of each contact strip is fixed to an inner surface of the sleeve 432, such as by welding as described above and shown in FIG. 29. The angular offset applied to the ends of each contact strip 434 prior to fixing to the outer sleeve 432 causes a center portion 436 of each contact strip 434 to have a hyperbolic shape suitable for forcibly engaging a conductive pin or other electrical member inserted there between as also described above.

In this aspect of the invention, at least one and preferably, two or more contact strips 434, such as contact strips 434 and 435 individually or in diametrically opposed pairs, are provided with a direct contact extension or portion 440 which extends from one end 442 fixedly mounted, such as by welding, to the inner surface of the outer sleeve 432. The extension 440 of the contact member 434 has an angular portion 441 extending from the end 442 to a generally planar portion 444 at an outer, opposite end thereof. The planar portion 444 is spaced from a similar planar portion 444 on the contact strip 435, both of which project axially outward from the sleeve 432 and overlay a generally planar portion 446 on the terminal. A pair of bendable collars or wire crimp members 450 and 452 are formed on the terminal 429 and extend from opposite sides of the planar portion 446 and are bendable about an insulation portion 454 of a conductor and the bare wire strands 456 of the conductor, respectively.

As shown in FIG. 48, the direct contact extensions 440 of the contact strips 434 and 435 are initially disposed on opposite sides of the ends of the bare wire strands 456. In this manner, when the pair of bendable collars 452 are forcibly bent around the ends of the direct contact extensions 440 and the bare wire strands 456, the ends of the direct contact extensions 440 are forcibly and directly engaged with the bare wire strands 456 as is a portion of the bendable collars 452. This increases the contact area between the conductor and the contact strips in the connector so as to enable a higher amperage current to be carried by the connector.

In summary, there has been depicted a unique electrical connector having radially resilient electrical socket constructed by a low cost method which makes use of a cylindrical portion on a mating holder which receives the barrel socket to eliminate one or two end collars employed in prior electrical barrel socket designs. Also disclosed is an electrical connector utilizing the inventive electrical socket which may be incorporated directly into another holder, support or even into an electrical use device, such as an automobile alternator, vehicle battery, etc.

Various constructions have been described for the electrical connector of the present invention which enable the connector to be formed with a small cross-section for use in many different applications; while at the same time having increased amperage despite the small outer diameter.

What is claimed is:

1. A method of manufacturing an electrical connector comprising the steps of:
forming a cylindrical contact member with a plurality of spaced strips having first and second ends extending between opposite ends of the contact member;
inserting the cylinder into a cylindrical sleeve;
angularly offsetting one of the first and second ends of each strip from the opposite one of the first and second ends of each strip;
non-movably fixing the angularly offset ends of the strips with respect to the sleeve; and
inserting the sleeve and the contact member into a bore in a use element.

2. The method of claim 1 comprising the steps of:
forming the contact member with the plurality of spaced strips integrally joined at opposite ends to a pair of spaced, webs extending continuously transversely across the contact member in inwardly spaced, parallel relationship to end edges of the contact member, and a plurality of spaced, longitudinally extending tabs projecting axially from each web to the end of the contact member;
bending the tabs at one end of the contact member into face-to-face engagement with an outer surface of the sleeve;
inserting the tabs and the one end of the sleeve into a bore in a first housing;
bending the tabs at the opposite end of the contact member over the other end of the sleeve;
the step of angularly offsetting the ends of each strip including angularly offsetting the tabs at the opposite end of the contact member from the tabs at the one end of the contact member;
inserting the opposite end of the contact member into a second housing coaxially aligned with the first housing; and
pushing the sleeve and the contact member from the first housing into the second housing wherein the second housing bends the tabs at the opposite end of the contact member over into face-to-face engagement with the sleeve.

3. The method of claim 2 further comprising a step of:
forming the second housing as a unitary, one piece part of the use element.

4. The method of claim 3 further comprising the steps of:
forming a plurality of longitudinally extending grooves in the second housing disposed parallel to the longitudinal axis of the cylinder; and
inserting the bent over tabs at each end of the contact member into one of the grooves as the sleeve and the contact member are urged into the second housing.

5. The method of claim 2 further comprising the step of:
forming the second housing of an electrically conductive material.

6. The method of claim 2 further comprising the steps of:
pushing the sleeve and the contact member from the co-axially aligned first and second housings into a holder.

7. The method of claim 6 further comprising the step of:
forming the holder as a unitary part of the use element.

8. The method of claim 1 further comprising the steps of:
forming the contact member with a plurality of spaced strips integrally joined at opposite ends to a pair of spaced webs extending continuously transversely across the contact member in inwardly spaced, parallel relationship to end edges of the contact member, and a plurality of spaced, longitudinally extending tabs projecting axially from each web to the end edges of the contact member;
bending the tabs at one end of the contact member over the first end of the sleeve;
inserting one end of the contact member into a first holder;
bending the tabs at the other end of the contact member over the second end of the sleeve;
the step of angularly offsetting including angularly one end of the strips at one end of the contact member now being preformed; and
while holding the ends of the strips in the angularly offset relationship, sliding the sleeve and the contact member into a cylindrical second holder where the second holder holds the ends of the strips in an angularly offset position.

9. The method of claim 8 further comprising the steps of:
sliding the contact member from the second holder completely into a cylindrical housing.

10. The method of claim 9 further comprising the steps of:
forming the second holder as a housing;
before angularly offsetting one end of the contact member with respect to the other end of the contact member, pushing the contact member into the housing and fixing the opposite end of the contact member in the housing;
then angularly offsetting the one end of the contact member with respect to the other end of the contact member; and
then fixing the first end of the contact member in the angularly offset position in the holder.

11. The method of claim 1 further comprising the steps of:
forming the contact member with a plurality of spaced strips integrally joined at opposite ends to a pair of spaced webs extending continuously transversely across the contact member and inwardly spaced, parallel relationship to the end edges of the contact member, and a plurality of spaced, longitudinally extending past projecting axially from each web to the end edges of the contact member;
flaring both ends of the strips from the longitudinal extent of the strips;
folding one flared end of each strip over the outer surface of the sleeve and inserting the folded over one end into a first holder;
folding the flared opposed ends of the strips over the opposed outer surface of the sleeve and inserting the opposed end of the strips into a second holder;
then angularly offsetting the one end of the contact member with respect to the opposed end of the contact member; and
then pushing the contact member and the sleeve from at least one of the first and second holders into a use holder.

12. The method of claim 11 further comprising the step of:
forming the second holder as a use holder.

13. The method of claim 11 further comprising the step of:
deforming a first end of the use holder about the contact strips.

14. The method of claim 11 wherein:
the step of angularly offsetting the first end of the strips with respect to the second end of the strips is preformed before steps of folding the second ends of the strips over the outer surface of the sleeve and inserting the second end of the strips and the contact member into the second holder.

15. The method of claim 11 further comprising the step of:
forming a plurality of longitudinally extending grooves disposed parallel to the longitudinal axis of the bore in the use element; and
inserting the folded over ends of the strips into one of the grooves as a sleeve is urged into the bore in the use element.

16. The method of claim 11 further comprising the steps of:
forming the bore in the first holder with a first diameter to interference fit with the tabs at the first end of the strips;
forming the second end of the bore with an initial diameter greater than the diameter of the folded over tabs at the second end of the strips;
then angularly offsetting the tabs at the second ends of the strips from the tabs at the first end of the strips; and
forming the second end of the holder into fitting engagement with the tabs on the second end of the strips to hold the tabs on the second end of the strips in face-to-face engagement with the cylindrical sleeve.

17. The method of claim 1 comprising the steps of:
initially forming the contact member as an electrically conductive blank with opposed ends;
providing the plurality of electrically conductive contact strips having one end extending from one end of the blank;
folding the strips over the one end of the blank toward the opposite end of the blank;
forming the blank into the cylinder; and
joining opposed ends of the strips to the sleeve after the cylindrical blank has been inserted into the sleeve.

18. The method of claim 17 further comprising the step of forming the strips as the unitary part of the blank.

19. The method of claim 17 further comprising the step of:
joining the strips as separate members to one end of the blank.

20. The method of claim 19 wherein the opposed ends of the strips project outwardly from the opposite end of the blank after the strips have been folded over the blank; and wherein
the step of joining the opposed ends of the strips to the sleeve comprises the steps of:
folding the opposed ends of the strips over an exterior surface of the sleeve; and
fixedly joining the folded over opposed ends of the strips to the exterior surface of the sleeve.

21. The method of claim 20 wherein the step of joining the opposed ends of the strips to the sleeve comprises the step of:
welding the opposite ends of the strips to the sleeve.

22. The method of claim 20 wherein the step of joining the opposed ends of the strips to the sleeve comprises the step of:
folding the opposed ends of the strips over an end portion of the sleeve; and
fixing the folded over portion of the opposed ends of the strips to the end portion of the sleeve.

23. The method of claim 17 further comprising the step of:
forming the strips of a different electrical conductive material than the material forming the blank.

24. The method of claim 1 comprising the steps of:
forming the contact member as an electrically conductive cylindrical blank with opposed ends;
providing a plurality of electrically conductive strips extending from one end fixed to one end of the blank; and
fixing the opposed ends of the strips to an interior surface of the blank after the opposed ends are angularly offset from the one end of each strip.

25. The method of claim 1 further comprising the steps of:
forming the contact member as a conductive blank;
fixing the plurality of strips to an intermediate portion of the blank;
then forming the blank into a cylinder;
the angularly offsetting step including angularly offsetting longitudinally outermost opposed ends of each strip with respect to a fixed intermediate portion of each strip; and
fixing the opposed end of the strips to the blank in the angularly offset position with respect to the fixed intermediate portion of each strip.

26. The method of claim 25 further comprising the step of:
inserting the sleeve and the contact member into a bore formed in a holder.

27. The method of claim 26 further comprising the step of:
disposing a seal between one end of the connector and the holder.

28. The method of claim 25 further comprising the step of:
inserting two electrically conductive pins through opposed ends of the sleeve into respective electrical contact with the strips extending from the intermediate fixed portions of the strips.

29. The method of claim 25 wherein the step of fixing the intermediate portion of each strip to the blank comprises the step of welding an intermediate portion of each strip to the blank.

30. The method of claim 1 further comprising the steps of:
forming the conductive contact member as a one piece member having the plurality of parallel contact strips;
forming laterally extending first and second webs connected to first and second ends of each strip;
forming the contact strips to extend angularly between the first and second webs;
then forming the contact member into a cylinder with the strips extending at an angle between with respect to longitudinal axis of the cylindrical contact member.

31. The method of claim 1 further comprising the step of:
mounting a resilient member intermediately between the opposed ends of the sleeve, the resilient member projecting radially inward and engaging an intermediate portion of each strip to bias the intermediate portion of each strip radially inward into a bore formed interiorly between the strips.

32. The method of claim 1 wherein the step of forming the contact member further comprises the steps of:
disposing first and second flat conductive blanks end-to-end;
fixing the plurality of strips in a spaced apart manner longitudinally across the first and second blanks;
fixing the first and second opposed ends of each strip to the first and second blanks, respectively;
forming each of the first and second blanks into first and second coaxially disposed cylinders;
angularly offsetting one of the first and second cylinders with respect to the other of the first and second cylinders; and
fixing the first and second cylinders in a coaxial arrangement in the angularly offset position.

33. The method of claim 32 further comprising the step of
fixedly joining lateral edges of each of the first and second blanks to each other.

34. The method of claim 1 further comprising the steps of:
forming the contact member as a flat blank having opposed ends and opposed side edges;
forming a plurality of open slots in the blank intermediate the opposed ends, the slots extending angularly with respect to a longitudinal axis between the opposed ends of the blank;
equally spacing and fixing the plurality of strips in parallel at opposed ends to the blank
forming the blank into the cylindrical sleeve wherein opposed side edges abut; and
the step of angularly offsetting the ends of the strips including angularly offsetting one end of the blank with respect to the other end of the blank to bring the slots into coaxial alignment with the longitudinal axis of the blank.

35. The method of claim 1 further comprising the steps of:
forming the contact member of an electrically conductive material in the form of a flat blank having opposed first and second ends;
forming a plurality of slits in the blank in two alternating groups of slits;
forming a first group of single slits, opposed ends of each slit in the first group of slits spaced from the first and second ends of the blank;
forming a second group of a plurality of pairs of two spaced slits, each extending inward from opposed first and second ends of the blank, respectively, inner ends of each pair of slits of the second group of slits being spaced apart, each of the slits in the first group of slits being actually aligned between the first and second ends of the blank;
laterally expanding the blank to form the first and second groups of slits into first and second groups of slots;
forming the expanded blank into the cylinder; and
rotating a first end of the cylinder with respect to the second end wherein solid portions of the blank disposed between adjacent slots of the second group of slots and one pair of slots in the first group of slits form the strips radially engagable with a conductive member inserted into the cylinder.

36. The method of claim 1 further comprising the step of:
forming a radially inward extending projection on at least one of the strips, the projection extending radially inward into a bore formed between the cylindrically arranged strips, and wherein the projection is adapted to releasably engage a recess in a conductive pin insertable through the sleeve into contact with the strips, the projection on the at least one strip releasably locking the conductive pin the sleeve.

37. The method of claim 1 further comprising the steps of:
forming the contact member as a conductive blank,
fixing one end of the plurality of strips to the blank;
integrally connecting an other end of each strip to a transversely extending web;
forming a plurality of tabs extending outwardly from one side of the web;
forming the blank into a cylindrical shaped sleeve;
the angularly offsetting step including angularly offsetting the tabs and the adjacent ends of the strips with respect to the opposite fixed ends of the strips; and
fixing the tabs in a position relative to the cylindrical shaped sleeve in a use element.

38. The method of claim 1 further comprising the steps of:
forming the contact member of an electrically conductive material in the form of a flat blank having opposed first and second side ends;
forming a plurality of slits alternatingly in the blank, with one strip extending from a first end at one side end of the blank to a second end spaced from an opposite side end of the blank and the adjacent slit extending from a first end at the opposite side end of the blank to a second end spaced from the one side end of the blank to form solid metal portions at alternating ends of two adjacent strips;
laterally expanding the blank to space one end of two adjacent strips from each other and spacing the opposed ends of two adjacent strips in contact by the solid metal portion fro an adjacent solid metal portion;
fixedly mounting the end of each strip to first and second spaced flat blanks;
forming the first and second blanks into cylindrical sleeves;
angularly rotating one of the sleeves with respect to the other sleeve to angularly offset one end of the strips from the opposite end of each strip; and
fixedly joining the first and second sleeves together to maintain the opposed ends of the strips in the angular offset position.

39. A connector comprising:
a cylindrical sleeve; and
a contact member coaxially received within the sleeve, the contact member including:
a plurality of circumferentially spaced strips having first and second ends, one of the first and second ends of each strip being angularly offset with respect to a longitudinal axis of the sleeve from the opposed end of the respective strip; and
the first and second ends of the strips non-movably fixed in the angularly offset position with respect to the sleeve.

40. The connector of claim 39 further comprising:
a use element having a bore extending from an open end;
a plurality of axially extending grooves formed in the body opening to the bore; and
the strips having at least one end folded over one end of the sleeve, the folded over end of the strips engaged with the grooves in the body to maintain the ends of the strips in the angularly offset position.

41. The connector of claim 40 wherein:
the body completely receives both ends of the sleeve and the strips.

42. The connector of claim 39 wherein:
the strips comprise the plurality of strips extending from one end of the sleeve;
the strips folded from the one end of the sleeve and extending interiorly through the sleeve to the opposite end of the sleeve; and
the opposed end of the strips fixed to the sleeve in an angularly offset position with respect to the one end of the strips.

43. The connector of claim 42 wherein:
the opposed ends of each strip are folded over an exterior surface of the sleeve and fixed to the exterior surface of the sleeve.

44. The connector of claim 42 wherein:
the opposed ends of the strips are folded over an end edge of the sleeve and fixed to the end edge of the sleeve.

45. The connector of claim 42 wherein:
the opposed ends of the strips terminate interiorly of the opposed end of the sleeve; and
the opposite ends of the strips are fixed to an interior surface of the sleeve.

46. The connector of claim 39 further comprising:
an intermediate portion of each strip fixedly attached to the sleeve;
opposed ends of each strip angularly offset with respect to a longitudinal axis of the sleeve from the fixed intermediate portions of each strip; and
the longitudinally outer ends of each strip fixed to the sleeve in the angular offset position.

47. The connector of claim 39 further comprising:
at least one of the strips having a projection extending radially inward from the at least one strip; and
the projection adapted to releasably engage a recess in a conductive pin insertable through the sleeve into contact with the strips, the projection on the at least one strip to releasably engagable with the recess to lock the conductive pin in the sleeve.

48. The connector of claim 47 wherein:
the projection on the at least one strip is disposed between opposed ends of the at least one strip.

49. The connector of claim 39 wherein:
the strips are joined to and extend from opposite ends joined to webs extending transversely to the opposed ends of the strips;
a plurality of tabs projecting longitudinally from each web and fixed to the sleeve; and
the strips preformed at an angle between the webs.

50. The connector of claim 39 further comprising:
an annular projection disposed intermediate the ends of the sleeve and biasing an intermediate portion of each strip radially inward.

51. The connector of claim 50 wherein the projection is an annular band carried on the sleeve.

52. The connector of claim 39 further comprising:
the contact member formed of a cylindrical blank having opposed first and second ends;
the plurality of strips mounted interiorly within the cylindrical blank and having first and second ends fixed to the first and second ends of the blank;
a plurality of slots formed in the blank, the slots nominally extending at an angle with respect to the strips; and
the first end of the cylindrical blank angularly offset with respect to the opposed second end of the blank such that the slots are substantially coaxially aligned with a longitudinal axis through the cylindrical blank and the first end of each strip is angularly offset from the second end of each strip with respect to the longitudinal axis through the cylindrical blank.

53. The connector of claim 39 further comprising:
the contact member formed of first and second, co-axial cylindrical blanks having facing first ends and opposed second ends;
the plurality of strips mounted interiorly within the first and second cylindrical blanks and having first and second ends fixed to the first and second ends of the first and second blanks, respectively; and
the second end of the second cylindrical blank angularly offset with respect to a longitudinal axis through the coaxial first and second blanks from the opposed second end of the first blank such that the first end of each strip is angularly offset from the second end of each strip with respect to the longitudinal axis.

54. The connector of claim 39 further comprising:
at least one strip on the contact member having an extension projecting from one end of the contact member;
a detent formed in the extension adapted to engage a recess formed in a conductive member insertable into the connector to forcibly retain the conductive member within the connector.

55. The connector of claim 54 wherein the detent locks into the recess to prevent removal of the conductive member from the connector after engagement with the detent.

56. The connector of claim 55 further comprising:
a release tab extending from the extension exteriorly of the sleeve to enable disengagement of the detent from the recess.

57. The connector of claim 39 further comprising:
at least one strip on the contact member having an extension projecting outward from one end of the sleeve;
the sleeve adapted to be mounted in a bore in a cylindrical end portion of a terminal, the terminal having an end portion extending from one end of the cylindrical portion terminating in at least one bendable wire crimp collar bendable about bare wire of a conductor; and
the extension on the at least one strip extending into engagement with the bare wire of an electrical conductor mounted on the end portion of the terminal and forcibly engaged with the bare wire upon bending of the collar about the end portion of the extension of the strip and the bare wire of the conductor.

58. The connector of claim 57 wherein the extension is formed on at least two strips of the contact member.

59. The connector of claim 39 wherein:
the strips comprise a plurality of strips having first and second ends, the first ends fixedly mounted to the interior of the cylindrical sleeve, the second ends integrally formed with a transversely extending web;
a plurality of tabs projecting outwardly from the web and the sleeve;
the tabs and the ends of the strips adjacent thereto being angularly offset with respect to the ends of the strips fixed to the sleeve.

60. The connector of claim 1 wherein the strips are formed of a continuous angularly expanded contact member formed of angularly disposed strips, with alternating ends of adjacent strips fixedly joined to each other by a solid metal portion of the contact member, the solid metal portions alternating from ends-to-ends of adjacent strips;
the strips fixedly mounted at opposite ends to first and second cylindrical sleeves; and
one end of each strip angularly offset from the other end of each strip.

61. An electrical connector mountable in a bore in an electrically conductive use element to provide an electrical connection between the use element and another element, the connector comprising:
a sleeve adapted to be coaxially received within the bore of a use element;
a contact member having a pair of axially spaced annular webs fixedly seated against the inner surface of the sleeve;
a plurality of elongate strips integrally joined at one end to one of the webs and integrally joined at an opposite end to the other of the webs, the strips being joined to the webs at uniformly spaced intervals about the respective to the circumference of the webs;
the location at which each strip is joined to one of the web being angularly displaced about the common axis of the webs from the location at which each respective strip is joined to the other of the webs;
a plurality of tabs integrally joined to each web and extending from the respective web around an adjacent end edge of the sleeve and into face-to-face engagement with an outer surface of the sleeve; and wherein;
the tabs and the strips are held by the inner surface of the bore in the use element in face-to-face engagement with an outer surface of the sleeve.

62. The electrical connector of claim 61 wherein the use element includes an electrical conductive portion connectable to an electrical device.

63. The electrical connector of claim 61 further comprising:
an electrically conductive pin attached to the another element insertable into electrical contact with the strips.

64. The connector of claim 61 further comprising:
a plurality of longitudinally axially extending grooves formed and opening to the bore in the use element; and
the tabs at each opposite end of the sleeve fixed within the grooves in the use element when the sleeve is seated in the bore in the use element.

65. The connector of claim 61 further comprising:
a pin insertable into the cylindrical contact member, the pin having a recess; and
at least one strip having an extension at one end, the extension having a radially inward projection engagable with the recess in the pin to lock the pin in the contact member.

66. The connector of claim 61 wherein the recess in the pin and the projection on the extension are shaped to prevent removal of the pin from the contact member.

67. An electrical connector comprising:
a terminal having a cylindrical portion with a bore;
a wire grip portion extending from one end of the cylindrical portion and terminating in a wire grip bendable into fixed engagement with a bare wire end and wire insulation of an electrical conductor;
a cylindrical contact member with a plurality of parallel, longitudinal strips fixed at opposite ends to the sleeve;
at least one strip having an extension projecting from one end in the sleeve, the extension contacting the bare wire end of the conductor; and
the wire grip portion bendable into fixed engagement with the bare wire end and the strip extension.

68. The connector of claim 67 further comprising:
at least two strips having an extension.

69. The connector of claim 68 wherein the extensions on the at least two strips are diametrically opposed.
